(19) United States
(12) Patent Application Publication
(10) Pub. No.: US 2018/0184357 A1
(43) Pub. Date: Jun. 28, 2018

(54) COMMUNICATION DEVICE AND INFORMATION DELIVERY SYSTEM

(71) Applicant: NEC Corporation, Minato-ku, Tokyo (JP)

(72) Inventors: Yasuhiro YAMASAKI, Tokyo (JP); Kazumine OGURA, Tokyo (JP)

(73) Assignee: NEC Corporation, Minato-ku, Tokyo (JP)

(21) Appl. No.: 15/580,010

(22) PCT Filed: Jun. 2, 2016
(86) PCT No.: PCT/JP2016/002674

§ 371 Date: Dec. 6, 2017

(30) Foreign Application Priority Data
Jun. 18, 2015 (JP) 2015-122965

(51) Int. Cl. H04W 40/20

(52) U.S. Cl. CPC H04W 40/20

(57) ABSTRACT

In order to shorten information delivery time, a communication device that transmits delivery information to another terminal comprises: a determination processing unit which, on the basis of a delivery destination of the delivery information, place information at the present time of the communication device, and delivery place information that associates the delivery destination and a copy destination, determines whether the delivery of the delivery information is permitted or not; and a transmission processing unit which, only when the determination processing unit determines that the delivery is permitted, transmits the delivery information to the other terminal.

### TECHNICAL FIELD

The present invention relates to an information delivery system delivering information in a network, and relates particularly to a communication device for promptly delivering information to a destination, a location, and a terminal.

### BACKGROUND ART

There is an information delivery system delivering information in a communication network including a plurality of fixed terminals and a plurality of mobile terminals, by inter-terminal communication. NPL 1 discloses such an information delivery system.

FIG. 1 is a system configuration diagram illustrating a configuration example of the information delivery system disclosed in NPL 1. The information delivery system illustrated in FIG. 1 includes nine fixed terminals Fi (i=1 to 9) installed at evacuation sites and four mobile terminals Mj (j=1 to 4) playing a role of propagating information between evacuation sites. In order to distinguish the nine fixed terminals, the fixed terminals are referred to as first to ninth fixed terminals F1 to F9, and, in order to distinguish the four mobile terminals, the mobile terminals are referred to as first to fourth mobile terminals M1 to M4 here. In such a configuration, information generated in a certain fixed terminal Fi (i=1 to 9) is delivered to another fixed terminal Fk (k=1 to 9, k≠i) through a mobile terminal Mj (j=1 to 4).

In the example of the information delivery system illustrated in FIG. 1, information generated in the first fixed terminal F1 is delivered to the fifth fixed terminal F5 through the first mobile terminal M1. Information generated in the second fixed terminal F2 is delivered to the sixth fixed terminal F6 through the second mobile terminal M2. Information generated in the eighth fixed terminal F8 is delivered to the seventh fixed terminal F7 through the third mobile terminal M3. Information generated in the eighth fixed terminal F8 is delivered to the sixth fixed terminal F6 through the fourth mobile terminal M4.

It is assumed that a mobile terminal Mj stays in the evacuation sites while the mobile terminal Mj is generating a replicate of information to the fixed terminal Fi or while generation of a replicate of information from the fixed terminal Fi to the mobile terminal Mj is taking place. It is assumed that a position of a fixed terminal is known since the evacuation sites can be previously obtained from a home page of a municipality, or the like.

Two related art examples are presented below as information replication devices (communication devices), information replication methods, and systems when delivering information in such an information delivery system.

The first related art example is an epidemic routing scheme adopted as multicast communication in NPL 2. NPL 2 describes details of the epidemic routing scheme. In the epidemic routing scheme, a terminal holding information always transmits a replicate of the held information to another terminal whenever an opportunity to be able to communicate with the other terminal exists, regardless of whether the terminal is a fixed terminal or a mobile terminal.

Next, using FIG. 2, a delivery process when the epidemic routing scheme is adopted as an information delivery method will be described.

An information delivery system illustrated in FIG. 2 includes nine fixed terminals Fi (i=1 to 9) and two mobile terminals Mj (j=1 to 2). Similarly to the case in FIG. 1, in order to distinguish the nine fixed terminals, the fixed terminals are referred to as first to ninth fixed terminals F1 to F9, and, in order to distinguish between the two mobile terminals, the mobile terminals are referred to as first and second mobile terminals M1 and M2.

As illustrated in FIG. 2, the first mobile terminal M1 travels between locations of the fixed terminals in a counterclockwise direction in order of the second fixed terminal F2, the first fixed terminal F1, the fourth fixed terminal F4, the seventh fixed terminal F7, the eighth fixed terminal F8, the ninth fixed terminal F9, the sixth fixed terminal F6, and the third fixed terminal F3. The second mobile terminal M2 travels between the locations of the fixed terminals in a clockwise direction in order of the seventh fixed terminal F7, the fourth fixed terminal F4, the first fixed terminal F1, the second fixed terminal F2, the third fixed terminal F3, the sixth fixed terminal F6, the ninth fixed terminal F9, and the eighth fixed terminal F8. It is assumed here that information A directed to the ninth fixed terminal F9 is generated in the first fixed terminal F1.

When the epidemic routing scheme is adopted as the information delivery method, a replicate of information A is generated in the first mobile terminal M1 at a time point when the first mobile terminal M1 reaches the first fixed terminal F1. Next, when the first mobile terminal M1 reaches the fourth mobile terminal F4, a replicate of the information A is generated in the fourth fixed terminal F4. As the first mobile terminal M1 travels thereafter, a replicate of the information A is similarly generated in each of the seventh fixed terminal F7, the eighth fixed terminal F8, the ninth fixed terminal F9, the sixth fixed terminal F6, and the third fixed terminal F3 in this order.

Similarly, a replicate of the information A is generated in the second mobile terminal M2 at a time point when the second mobile terminal M2 reaches the first fixed terminal F1. As the second mobile terminal M2 travels thereafter, a replicate of the information A is generated in each of the second fixed terminal F2, the third fixed terminal F3, the sixth fixed terminal F6, the ninth fixed terminal F9, and the eighth fixed terminal F8 in this order.

At a location where a replicate of information is generated (the third fixed terminal F3, the sixth fixed terminal F6, the ninth fixed terminal F9, or the eighth fixed terminal F8 in this example), information is replicated from a mobile terminal reaching the location earlier, regardless of whether the terminal is the first mobile terminal M1 or the second mobile terminal M2. When the information is already replicated and a mobile terminal subsequently reaches the location, the information is not replicated again.

When such information delivery is performed, replicates of the information A are consequently generated at the locations other than the fifth fixed terminal F5. Further, when the information A is delivered to a destination (the ninth fixed terminal F9 in this example) through the first mobile terminal M1, replication of the information takes place five times. Specifically, replication of the information takes place at first to fifth replication points described below. The first replication point is a point where replication from the first fixed terminal F1 to the first mobile terminal M1 takes place. The second replication point is a point where replication from the first mobile terminal M1 to the fourth fixed terminal F4 takes place. The third replication point is a point where replication from the first mobile terminal M1 to the seventh fixed terminal F7 takes place. The fourth replication point is a point where replication from the first mobile terminal M1 to the eighth fixed terminal F8 takes place. The fifth replication point is a point where replication from the first fixed terminal M1 to the ninth fixed terminal F9 takes place.

Further, replication of the information A also takes place five times when the information is delivered to a destination (the ninth fixed terminal F9 in this example) through the second mobile terminal M2. Specifically, replication of the information takes place at first to fifth replication points described below. The first replication point is a point where replication from the first fixed terminal F1 to the second mobile terminal M2 takes place. The second replication point is a point where replication from the second mobile terminal M2 to the second fixed terminal F2 takes place. The third replication point is a point where replication from the second mobile terminal M2 to the third fixed terminal F3 takes place. The fourth replication point is a point where replication from the second mobile terminal M2 to the sixth fixed terminal F6 takes place. The fifth replication point is a point where replication from the second mobile terminal M2 to the ninth fixed terminal F9 takes place.

The second related art example is a hierarchical routing scheme adopted as unicast communication in NPL 3. NPL 3 describes details of the hierarchical routing scheme. In the hierarchical routing scheme, each terminal holds an encounter history related to terminals encountered in the past and determines a reaching probability, based on the encounter history, regardless of whether the terminal is a fixed terminal or a mobile terminal. Further, in the hierarchical routing scheme, a route with a high reaching probability is determined to be a next transfer terminal. Using FIG. 2, similarly to the case of the aforementioned epidemic routing scheme, a delivery process when the hierarchical routing scheme is adopted as the information delivery method will be described.

In FIG. 2, order of traveling between the fixed terminal locations by the first mobile terminal M1 is as described above. Further, order of traveling between the fixed terminal locations by the second mobile terminal M2 is also as described above. Further, it is similarly assumed that information A directed to the ninth fixed terminal F9 is generated in the first fixed terminal F1.

When the hierarchical routing scheme is adopted as the information delivery method, at a time point when first reaching the first fixed terminal F1, the first mobile terminal M1 has no encounter experience with the ninth fixed terminal F9, and therefore a reaching probability is zero. Accordingly, a replicate of the information A is not generated in the first mobile terminal M1. Subsequently, the first mobile terminal M1 travels to the fourth fixed terminal F4, the seventh fixed terminal F7, and the eighth fixed terminal F8. Then, at a time point when reaching the ninth fixed terminal F9, the first mobile terminal M1 has an encounter experience, and an encounter history related to the ninth fixed terminal F9 is generated in the first mobile terminal M1 for the first time.

Similarly, the second mobile terminal M2 also has no encounter experience with the ninth fixed terminal F9 at a time point when first reaching the first fixed terminal F1, and therefore a reaching probability is zero. Accordingly, a replicate of the information A is not generated in the second mobile terminal M2. Subsequently, the second mobile terminal M2 travels to the second fixed terminal F2, the third fixed terminal F3, and the sixth fixed terminal F6. Then, at a time point when achieving the ninth fixed terminal F9, the second mobile terminal M2 has an encounter experience, and an encounter history related to the ninth fixed terminal F9 is generated in the second mobile terminal M2 for the first time.

Thus, each of the first and second mobile terminals M1 and M2 just generates an encounter history in the first round and actual transfer of information does not take place.

Since a reaching probability with respect to the ninth fixed terminal F9 exists in the first mobile terminal M1 in the second round, a replicate of the information A is generated in the first mobile terminal M1 at a time point when the first mobile terminal M1 reaches the first fixed terminal F1. Subsequently, the first mobile terminal M1 travels to the fourth fixed terminal F4, the seventh fixed terminal F7, and the eighth fixed terminal F8. Then, at a time point when the first mobile terminal M1 reaches the ninth fixed terminal F9, the information A in the first mobile terminal M1 is replicated to the ninth fixed terminal F9. Note that, unlike the epidemic routing scheme, even when the first mobile terminal M1 reaches the fourth, seventh, and eighth fixed terminals F4, F7, and F8, an encounter history related to the ninth fixed terminal F9 does not exist on the fixed terminal side in the hierarchical routing scheme. Accordingly, the information A is not replicated in the fourth, seventh, and eighth fixed terminals F4, F7, and F8.

Similarly, since a reaching probability with respect to the ninth fixed terminal F9 exists in the second mobile terminal M2 in the second round, a replicate of the information A is generated in the second mobile terminal M2 at a time point when the second mobile terminal M2 reaches the first fixed terminal F1. Subsequently, the second mobile terminal M2 travels to the second fixed terminal F2, the third fixed terminal F3, and the sixth fixed terminal F6. Then, the second mobile terminal M2 replicates the information A to the ninth fixed terminal F9 at a time point when the second mobile terminal M2 reaches the ninth fixed terminal F9. Again, even when the second mobile terminal M2 encounters the second, third, and sixth fixed terminals F2, F3, and F6, an encounter history related to the ninth fixed terminal F9 does not exist on the fixed terminal side. Accordingly, the information A is not replicated in the second, third, and sixth fixed terminals F2, F3, and F6.

### CITATION LIST

### Non Patent Literature

NPL 1: Yasuhiro Yamasaki, Hirofumi Ueda, Kazumine Ogura, Norio Yamagaki, and Norihito Fujita, “Distributed Information Sharing System Using DTN and Field Trial for Disaster Relief,” IEICE-NS2013-16, May, 2013
NPL 2: A. Vandat and D. Becker, “Epidemic routing for partially-connected ad hoc networks,” Duke Technical Report, CS2000-06, 2000
NPL 3: Kazumine Ogura, Hirofumi Ueda, Norihito Fujita, “A hierarchical routing protocol for scalable DTN environments,” IEICE General Conference, B-7-20, March, 2013
NPL 4: Kazumine Ogura, Yasuhiro Yamasaki, Norihito Fujita, “A delivery method for information sharing at a specific spatial area,” IEICE technical report (CQ2013-53), November, 2013

### SUMMARY OF INVENTION

### Technical Problem

Items that are regarded as important in information delivery include reachability of information and a delivery speed of information. In the information delivery system in FIG. 1 in which information sharing between evacuation sites is performed by a staff member freely coming and going between the evacuation sites, destinations of the staff member are limited to a finite number. Accordingly, information reaches a destination within a finite time. Thus, it is important to shorten a delivery time of information (a time between generation of information and arrival at a destination) in such an information delivery system.

Using FIG. 3, a concept of the delivery time of information will be described, taking information delivery by the epidemic routing scheme as an example. When information arrives at a destination, a route through which the information passes is considered by calculating backwards.

A route when information reaches the ninth fixed terminal F9 from the first fixed terminal F1 by the first mobile terminal M1 by the epidemic routing scheme may be expressed by a pattern 1 in FIG. 3. In the pattern 1, information A generated in the first fixed terminal F1 is replicated to the first mobile terminal M1. Subsequently, the first mobile terminal M1 travels, and the information A is also replicated to the ninth fixed terminal F9. In such a situation, components of a total travel time T(A) of the information A from one fixed terminal (delivery source) to another fixed terminal (delivery destination) will be considered.

The total travel time T(A) is composed of a sum total of first to tenth partial times described below. The first partial time is a reaching time required for the first mobile terminal M1 to reach the first fixed terminal F1. The second partial time is a replication time required for the information A to be replicated in the first fixed terminal F1. The third partial time is a travel time required for the first mobile terminal M1 to travel from the first fixed terminal F1 to the fourth fixed terminal F4. The fourth partial time is a replication time required for the information A to be replicated in the fourth fixed terminal F4. The fifth partial time is a travel time required for the first mobile terminal M1 to travel from the fourth fixed terminal F4 to the seventh fixed terminal F7. The sixth partial time is a replication time required for the information A to be replicated in the seventh fixed terminal F7. The seventh partial time is a travel time required for the first mobile terminal M1 to travel from the seventh fixed terminal F7 to the eighth fixed terminal F8. The eighth partial time is a replication time required for the information A to be replicated in the eighth fixed terminal F8. The ninth partial time is a travel time required for the first mobile terminal M1 to travel from the eighth fixed terminal F8 to the ninth fixed terminal F9. The tenth partial time is a replication time required for the information A to be replicated in the ninth fixed terminal F9.

That is to say, in general, a total travel time T for information to travel from a certain location (delivery source) to a next location (delivery destination) is composed of a sum total of a first time T(1), a second time T(2), and a third time T(3) respectively described below. The first time T(1) is a reaching time required for a mobile terminal finally transporting the information to arrive at a fixed terminal and replicate the information. The second time T(2) is a travel time required for the mobile terminal to travel between fixed terminals. The third time T(3) is a replication time required for the mobile terminal to replicate the information while traveling.

It is assumed in the example in FIG. 3 that a travel time between fixed terminals adjacent to one another is a constant value of X, and the time required for replicating the information A is Y. In this case, a total travel time T(A) in the first related art example is obtained as follows.
first time T(1)=X (a reaching time required for reaching the first fixed terminal F1 from the second fixed terminal F2)
second time T(2)=4X (a travel time from the first fixed terminal F1 to the fourth fixed terminal F4, a travel time from the fourth fixed terminal F4 to the seventh fixed terminal F7, a travel time from the seventh fixed terminal F7 to the eighth fixed terminal F8, and a travel time from the eighth fixed terminal F8 to the ninth fixed terminal F9)
third time T(3)=5Y (replication times required for replicating the information in the first, fourth, seventh, eighth, and ninth fixed terminals F1, F4, F7, F8, and F9)

A problem with the first related art example is an increased information delivery count causing increase in the third time T(3), that is, an information replication count. The reason is that a mobile terminal performs information replication with respect to every encountered fixed terminal.

Similarly, a total travel time T(A) in the second related art example is obtained as follows.
first time T(1)=9X (a reaching time required for making a round and additionally reaching the first fixed terminal F1 from the second fixed terminal F2)
second time T(2)=4X (a travel time from the first fixed terminal F1 to the fourth fixed terminal F4, a travel time from the fourth fixed terminal F4 to the seventh fixed terminal F7, a travel time from the seventh fixed terminal F7 to the eighth fixed terminal F8, and a travel time from the eighth fixed terminal F8 to the ninth fixed terminal F9)
third time T(3)=2Y (replication times required for replicating the information in the first and ninth fixed terminals F1 and F9)

In the second related art example, while an information replication time being the third time T(3) is minimized, a reaching time being the first time T(1) for initially generating a reaching route in the first mobile terminal M1 is required. Consequently, in the second related art example, a lengthened first time T(1) required before information is initially replicated from the first fixed terminal F1 to the first mobile terminal M1 becomes a problem.

In other words, a problem with the second related art example is a lengthened first time T(1) required for a mobile terminal finally transporting information to arrive at a fixed terminal and replicate the information. The reason is that a replicate of the information is generated only in a terminal holding a reaching route, and therefore a reaching time for the mobile terminal to travel for a certain amount of time once and generate a reaching route with respect to each fixed terminal is required.

Further, a common problem with the first and second related art examples is a lengthened second time T(2) required for a mobile terminal to travel between fixed terminals. The reason is that a determination criterion for whether or not to replicate information does not include indicators such as a distance to a destination and a travel time. Replication of information is determined based on an attribute of a terminal such as every contacted “terminal” in the first related art example and a “terminal” with a reaching probability with respect to a destination in the second related art example, instead of a time or a distance. Accordingly, the first and second related art examples do not necessarily take into consideration a logical (temporal) or physical distance from a source location (delivery source) of information to a destination (delivery destination) of the information.

Consequently, the first time T(1), the second time T(2), and the third time T(3) in the first and second related art examples have characteristics as indicated in FIG. 4.

An example of the first mobile terminal M1 directly transporting the information A from the first fixed terminal F1 to the ninth fixed terminal F9 has been described in this example. However, a form of the first mobile terminal M1 transporting information B from the first fixed terminal F1 to the seventh fixed terminal F7 on the route and a separate third mobile terminal M3 transporting information C from the seventh fixed terminal F7 to the ninth fixed terminal F9 as illustrated in a pattern 2 in FIG. 3 may be similarly discussed. At this time, each of a total travel time T(B) of the information B and a total travel time T(C) of the information C is composed of a first time T(1), a second time T(2), and a third time T(3). Consequently, a total travel time from information generation to information arrival, that is, from the first fixed terminal F1 to the ninth fixed terminal F9, is composed of a first time T(1), a second time T(2), and a third time T(3).

An object of the present invention is to provide a technology for solving the aforementioned problems, that is, to shorten an information delivery time.

### Solution to Problem

A communication device according to first aspect of the present invention is a communication device transmitting delivery information to another terminal, and a communication device comprises: a determination processing unit determining whether or not to permit delivery of delivery information, based on a delivery destination of delivery information, location information of a communication device at a present moment, and delivery location information associating a delivery destination with a replication destination; and a transmission processing unit transmitting delivery information to another terminal only when the determination processing unit determines to permit delivery.

A communication device according to second aspect of the present invention is a communication device receiving delivery information from another terminal, and a communication device comprises: a reception processing unit receiving delivery information from another terminal; and a determination processing unit determining whether or not to permit import of delivery information received by the reception processing unit, based on a delivery destination of delivery information, location information of a communication device at a present moment, and delivery location information associating a delivery destination with a replication destination.

A communication device according to third aspect of the present invention is a communication device receiving delivery information from a first other terminal and transmitting a delivery information to a second other terminal, a communication device comprises: a reception processing unit receiving delivery information from a first other terminal; a determination processing unit determining whether or not to permit delivery of delivery information and determining whether or not to permit import of delivery information received by the reception processing unit, based on a delivery destination of delivery information, location information of a communication device at a present moment, and delivery location information associating a delivery destination with a replication destination; and a transmission processing unit transmitting delivery information to a second other terminal only when the determination processing unit determines to permit delivery.

An information delivery system according to another aspect of the present invention comprises a communication network including a plurality of fixed terminals and at least one mobile terminal traveling while communicating with the plurality of fixed terminals, wherein delivery information generated at a delivery source being one of the plurality of fixed terminals is delivered to a delivery destination being another one of the plurality of fixed terminals through the mobile terminal, each of the plurality of fixed terminals includes the communication device according to any one of the first aspect to the third aspect, and the mobile terminal includes the communication device according to the third aspect.

An information delivery system according to yet another aspect of the present invention comprises a communication network including a plurality of mobile terminals, wherein delivery information is delivered between the plurality of mobile terminals, and each of the plurality of mobile terminals includes the communication device according to any one of the first aspect to the third aspect.

### Advantageous Effects of Invention

The present invention is able to shorten an information delivery time.

### BRIEF DESCRIPTION OF DRAWINGS

FIG. 1 is a system configuration diagram illustrating a configuration example of an information delivery system disclosed in NPL 1.

FIG. 2 is a system configuration diagram for illustrating delivery processes of first and second related art examples.

FIG. 3 is a diagram for illustrating a concept of an information delivery time.

FIG. 4 is a diagram illustrating characteristics of a first time, a second time, and a third time in the first and second related art examples.

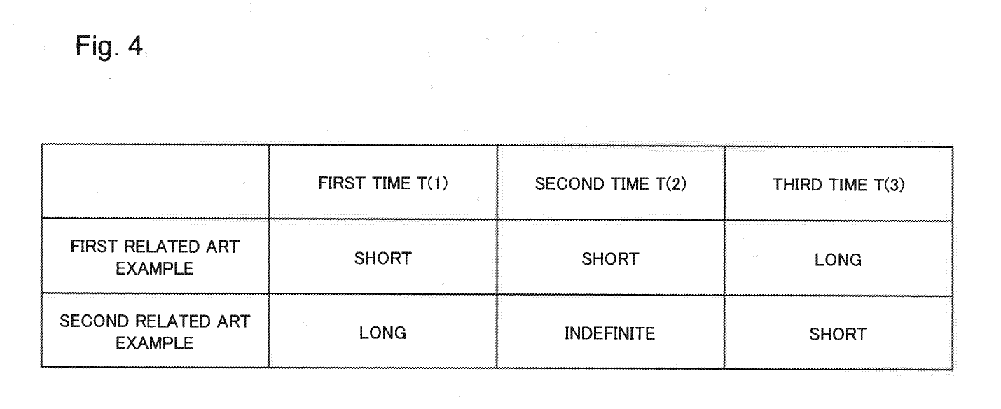

FIG. 5 is a block diagram illustrating a communication device according to a first example embodiment of the present invention.

FIG. 6 is a block diagram illustrating a communication device according to a second example embodiment of the present invention.

FIG. 7 is a block diagram illustrating a communication device according to a third example embodiment of the present invention.

FIG. 8 is a block diagram illustrating a communication device according to a fourth example embodiment of the present invention.

FIG. 9 is a block diagram illustrating a communication device according to a fifth example embodiment of the present invention.

FIG. 10 is a block diagram illustrating a communication device according to a sixth example embodiment of the present invention.

FIG. 11 is a block diagram illustrating a communication device according to a seventh example embodiment of the present invention.

FIG. 12 is a block diagram illustrating a communication device according to an eighth example embodiment of the present invention.

FIG. 13 is a block diagram illustrating a communication device according to a ninth example embodiment of the present invention.

FIG. 14 is a block diagram illustrating a communication device according to a tenth example embodiment of the present invention.

FIG. 15 is a block diagram illustrating a communication device according to an eleventh example embodiment of the present invention.

FIG. 16 is a block diagram illustrating a terminal (communication device) according to a first example of the present invention.

FIG. 17 is a diagram illustrating an example of delivery information stored in a delivery information DB used by the terminal illustrated in FIG. 16.

FIG. 18 is a diagram illustrating an example of delivery location information stored in a delivery location storage unit used by the terminal illustrated in FIG. 16.

FIG. 19 is a flowchart illustrating a flow of generation processing when generating information in the terminal illustrated in FIG. 16.

FIG. 20 is a flowchart illustrating a flow of reception processing when the terminal illustrated in FIG. 16 encounters another terminal and receives information from the another terminal.

FIG. 21 is a flowchart illustrating a flow of reception processing when the terminal illustrated in FIG. 16 encounters another terminal and transmits information to the another terminal.

FIG. 22 is a diagram illustrating another example of delivery information stored in the delivery information DB used by the terminal illustrated in FIG. 16.

FIG. 23 is a diagram illustrating another example of delivery location information stored in the delivery location storage unit used by the terminal illustrated in FIG. 16.

FIG. 24 is a diagram illustrating yet another example of delivery location information stored in the delivery location storage unit used by the terminal illustrated in FIG. 16.

FIG. 25 is a system configuration diagram illustrating another information delivery system (an ad hoc network) to which the terminal illustrated in FIG. 16 is applicable.

FIG. 26 is a system configuration diagram illustrating yet another information delivery system to which the terminal illustrated in FIG. 16 is applicable.

FIG. 27 is a system configuration diagram illustrating an information delivery system obtained by virtually regarding a mobile terminal as a fixed terminal in the information delivery system illustrated in FIG. 26.

FIG. 28 is a block diagram illustrating a terminal (communication device) according to a second example of the present invention.

FIG. 29 is a flowchart illustrating a flow of reception processing when the terminal illustrated in FIG. 28 encounters another terminal and receives information from the another terminal.

FIG. 30 is a flowchart illustrating a flow of reception processing when the terminal illustrated in FIG. 28 encounters another terminal and transmits information to the another terminal.

FIG. 31 is a block diagram illustrating a terminal (communication device) according to a third example of the present invention.

FIG. 32 is a diagram illustrating an example of delivery location information stored in a delivery location storage unit used by the terminal illustrated in FIG. 31.

FIG. 33 is a flowchart illustrating a flow of switching processing performed by a switching processing unit used by the terminal illustrated in FIG. 31.

FIG. 34 is a block diagram illustrating a terminal (communication device) according to a fourth example of the present invention.

FIG. 35 is a configuration diagram illustrating an example of connections of fixed terminals in an information delivery system, for illustrating an example of an operation in a replication location calculation unit in the terminal illustrated in FIG. 34.

FIG. 36 is a diagram illustrating an inner product calculation example in a fifth specifying method performed in the replication location calculation unit in the terminal illustrated in FIG. 34.

### EXAMPLE EMBODIMENT

### Overview of Example Embodiments of Present Invention

First, an overview of example embodiments of the present invention will be described in order to facilitate understanding of the example embodiments of the present invention.

An information replication method according to a first form of the present invention determines a location (delivery location) where a replicate of information is generated, based on a destination (delivery destination), and generates a replicate of the information only in a terminal encountered at the delivery location.

With such a mechanism, replication of information from a fixed terminal Fi to a mobile terminal Mj operates as follows. Specifically, in the information replication method according to the first form of the present invention, a fixed terminal Fi selects information held by the fixed terminal Fi and not by a mobile terminal Mj, in whole or in part, and replicates the information to the mobile terminal Mi. Note that the fixed terminal Fi holding information means that the location is specified as a replication location of the information. When a mobile terminal Mj not holding a replicate of the information reaches the location, the fixed terminal Fi generates a replicate of the information in the mobile terminal Mj.

On the other hand, replication of information from a mobile terminal Mj to a fixed terminal Fi operates as follows. Specifically, in the information replication method according to the first aspect of the present invention, out of information held by a mobile terminal Mj and not by a fixed terminal Fi, the mobile terminal Mj replicates information only to a fixed terminal Fi specified as a replication location of the information.

Thus, when a mobile terminal Mj arrives at a fixed terminal Fi, the information replication method according to the first form of the present invention replicates information triggered by arrival of the mobile terminal at the location, regardless of an attribute of the mobile terminal Mj such as whether or not a reaching probability is held therein. Accordingly, the first form of the present invention does not require time to generate route information in a terminal and is able to shorten a first time T(1).

Further, in an information replication method according to a second form of the present invention, even when a mobile terminal Mj arrives at a fixed terminal Fi, information is not replicated at a location not contributing to transport of the information to a destination (delivery destination). Accordingly, the second form of the present invention does not replicate information at an unnecessary location and is able to shorten a third time T(3).

Furthermore, an information replication method according to a third form of the present invention determines a location where a replicate of each piece of information is generated and generates a replicate of information only in a terminal encountered at the location. Then, the information replication method according to the third form of the present invention is able to shorten time for a mobile terminal Mj to travel, by determining the location where a replicate of the information is generated in consideration of a logical (e.g. temporal or stochastic) or physical distance from a source location of the information (delivery source) to a destination (delivery destination). In other words, the information replication method according to the third form of the present invention does not specify a logically or physically distant route as a replication location. Thus, the third form of the present invention is able to shorten a second time T(2).

Accordingly, effects of the example embodiments of the present invention are as follows.

A first effect of the example embodiments of the present invention is that a first time T(1) (reaching time), which is required time for a mobile terminal Mj finally transporting information arriving at a fixed terminal Mi to replicate information, can be shortened.

A second effect of the example embodiments of the present invention is that a second time T(2) (travel time), which is required time for the mobile terminal Mj to travel between the fixed terminals Fi, can be shortened.

A third effect of the example embodiments of the present invention is that a third time T(3) (replication time), which is required time for the mobile terminal Mj to replicate information while traveling, can be shortened.

By the aforementioned three effects, the example embodiments of the present invention are able to shorten a delivery time of information required from generation of information at a source location (delivery source) to arrival of the information at a destination (delivery destination) (time from generation of information to arrival of the information at a destination).

Referring to drawings, the example embodiments of the present invention will be described in detail below.

### First Example Embodiment

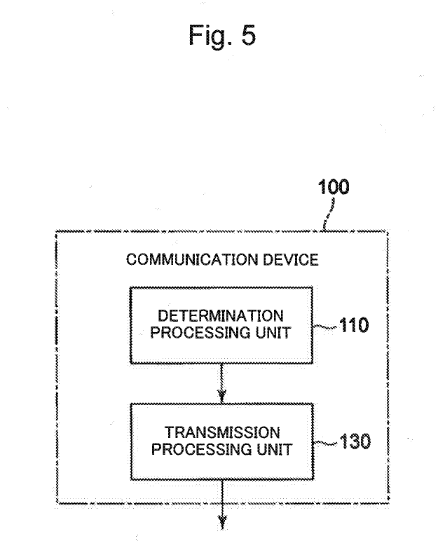

FIG. 5 is a block diagram illustrating a communication device 100 according to a first example embodiment of the present invention.

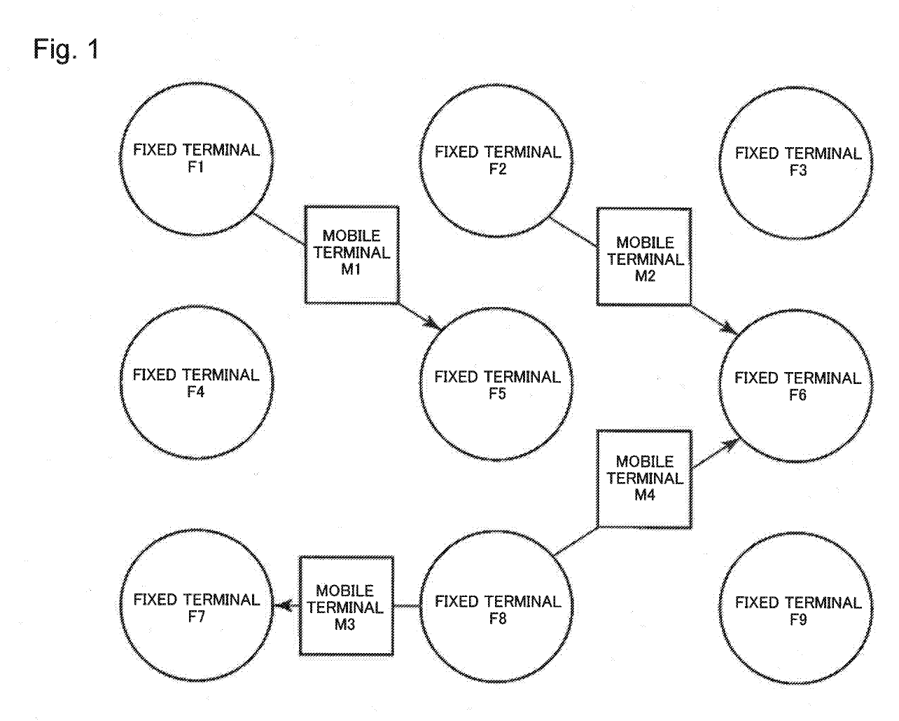

The illustrated communication device 100 is a communication device transmitting delivery information to another terminal (unillustrated). The communication device 100 is used as a mobile terminal Mj or a fixed terminal Fi constituting the information delivery system illustrated in FIG. 1. When the communication device 100 is a mobile terminal Mj, the other terminal is a fixed terminal Fi. On the other hand, when the communication device 100 is a fixed terminal Fi, the other terminal is a mobile terminal Mj.

Specifically, since the illustrated communication device 100 only performs transmission of delivery information, it is preferable that the communication device 100 be used as a fixed terminal other than a delivery destination. More specifically, in the case of the information delivery system illustrated in FIG. 1, it is desirable that the communication device 100 be used as the first, second, and eighth fixed terminals F1, F2, and F8.

The illustrated communication device 100 includes a determination processing unit 110 and a transmission processing unit 130.

The determination processing unit 110 determines whether or not to permit delivery of delivery information, based on delivery destination information indicating a delivery destination of the delivery information, location information indicating a location of the communication device 100 at a present moment, and delivery location information indicating a delivery location that associates a delivery destination with a replication destination.

The transmission processing unit 130 transmits delivery information to another terminal only when the determination processing unit 110 determines to permit delivery of the delivery information.

In the illustrated example, delivery information includes both or one of two types of information being delivery destination information and source information (delivery source information) indicating a source (delivery source) of the delivery information, in addition to an information body.

The communication device 100 according to the first example embodiment of the present invention with such a configuration provides an effect that an information delivery time can be shortened. The reason is that a location (delivery location) where a replicate of information is generated is determined based on a destination (delivery destination), and therefore there is no need for time to generate route information in a terminal. Consequently, a first time T(1) can be shortened.

### Second Example Embodiment

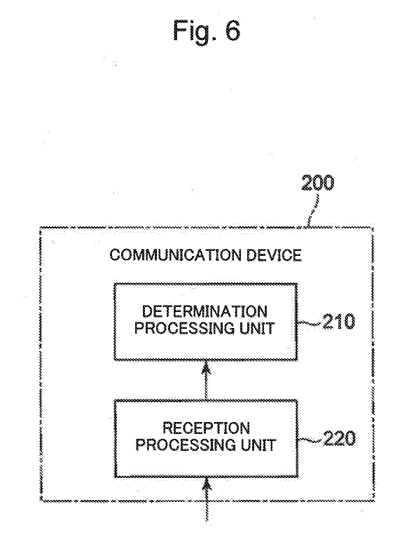

FIG. 6 is a block diagram illustrating a communication device 200 according to a second example embodiment of the present invention.

The illustrated communication device 200 is a communication device receiving delivery information from another terminal (unillustrated). The communication device 200 also is used as a mobile terminal Mj or a fixed terminal Fi constituting the information delivery system illustrated in FIG. 1. When the communication device 200 is a mobile terminal Mj, the other terminal is a fixed terminal Fi. On the other hand, when the communication device 200 is a fixed terminal Fi, the other terminal is a mobile terminal Mj.

Specifically, since the illustrated communication device 200 only performs reception of delivery information, it is preferable that the communication device 200 be used as a fixed terminal other than a delivery source. More specifically, in the case of the information delivery system illustrated in FIG. 1, it is desirable that the communication device 200 be used as the fifth, sixth, and seventh fixed terminals F5, F6, and F7.

The illustrated communication device 200 includes a determination processing unit 210 and a reception processing unit 220.

The reception processing unit 220 receives delivery information from another terminal.

The determination processing unit 210 determines whether or not to permit import of delivery information received by the reception processing unit 220, based on delivery destination information indicating a delivery destination of the delivery information, location information indicating a location of the communication device 200 at a present moment, and delivery location information indicating a delivery location that associates a delivery destination with a replication destination.

In the illustrated example, delivery information includes both or one of two types of information being delivery destination information and source information (delivery source information) indicating a source (delivery source) of the delivery information, in addition to an information body.

The communication device 200 according to the second example embodiment of the present invention with such a configuration provides an effect that an information delivery time can be shortened. The reason is that a location (delivery location) where a replicate of information is generated is determined based on a destination (delivery destination), and the information is not replicated at a location not contributing to transport of the information to the destination (delivery destination). Consequently, a third time T(3) can be shortened.

### Third Example Embodiment

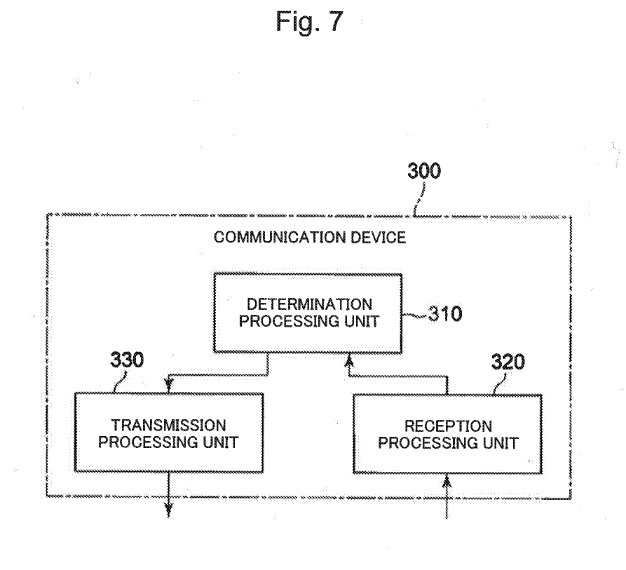

FIG. 7 is a block diagram illustrating a communication device 300 according to a third example embodiment of the present invention.

The illustrated communication device 300 is a communication device receiving delivery information from another terminal (unillustrated) and transmitting delivery information to another terminal (unillustrated). The communication device 300 also is used as a mobile terminal Mj or a fixed terminal Fi constituting the information delivery system illustrated in FIG. 1. When the communication device 300 is a mobile terminal Mj, the other terminal is a fixed terminal Fi. On the other hand, when the communication device 300 is a fixed terminal Fi, the other terminal is a mobile terminal Mi.

Specifically, since the illustrated communication device 300 performs both reception and transmission of delivery information, it is preferable that the communication device 300 be used as a mobile terminal, and a fixed terminal other than a delivery destination and a delivery source. More specifically, in the case of the information delivery system illustrated in FIG. 1, it is desirable that the communication device 300 be used as the first to fourth mobile terminals M1, M2, M3, and M4, and the third, fourth, and ninth fixed terminals F3, F4, and F9.

The illustrated communication device 300 includes a determination processing unit 310, a reception processing unit 320, and a transmission processing unit 330.

The reception processing unit 320 receives delivery information from another terminal.

The determination processing unit 310 determines whether or not to permit delivery of delivery information and also determines whether or not to permit import of delivery information received by the reception processing unit 320, based on delivery destination information indicating a delivery destination of delivery information, location information indicating a location of the communication device 300 at a present moment, and delivery location information indicating a delivery location that associates a delivery destination with a replication destination.

The transmission processing unit 330 transmits delivery information to another terminal only when the determination processing unit 310 determines to permit delivery of the delivery information.

In the illustrated example, delivery information includes both or one of two types of information being delivery destination information and source information (delivery source information) indicating a source (delivery source) of the delivery information, in addition to an information body.

The communication device 300 according to the third example embodiment of the present invention with such a configuration provides an effect that an information delivery time can be shortened. The reason is that a location (delivery location) where a replicate of information is generated is determined based on a destination (delivery destination), and therefore there is no need for time to generate route information in a terminal, and the information is not replicated at a location not contributing to transport of the information to the destination (delivery destination). Consequently, a first time T(1) and a third time T(3) can be shortened.

### Fourth Example Embodiment

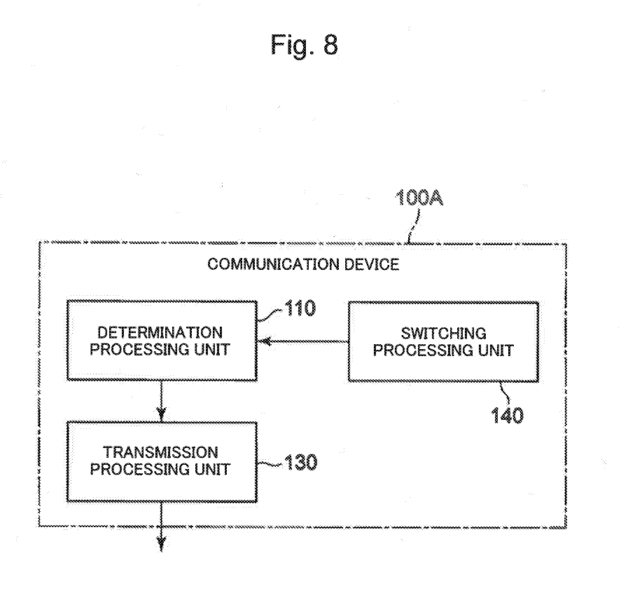

FIG. 8 is a block diagram illustrating a communication device 100A according to a fourth example embodiment of the present invention.

The illustrated communication device 100A has a configuration similar to that of the communication device 100 illustrated in FIG. 5 except for further including a switching processing unit 140, and operates similarly. Accordingly, a component having a function similar to that of the communication device 100 illustrated in FIG. 5 is given a same reference sign. For simplification of description, only a difference from the communication device 100 in FIG. 5 will be described below.

The switching processing unit 140 changes delivery location information depending on a communication environment. The switching processing unit 140 determines the communication environment, based on both or one of two types of information being residence time information indicating a residence time during which the communication device 100A stays at a certain location, and travel time information indicating a travel time required for the communication device 100A to travel from one location to another location.

The communication device 100A according to the fourth example embodiment of the present invention with such a configuration provides an effect that an information delivery time can be shortened. The reason is that a delivery location is changed in consideration of a communication environment such as a travel time and a residence time.

### Fifth Example Embodiment

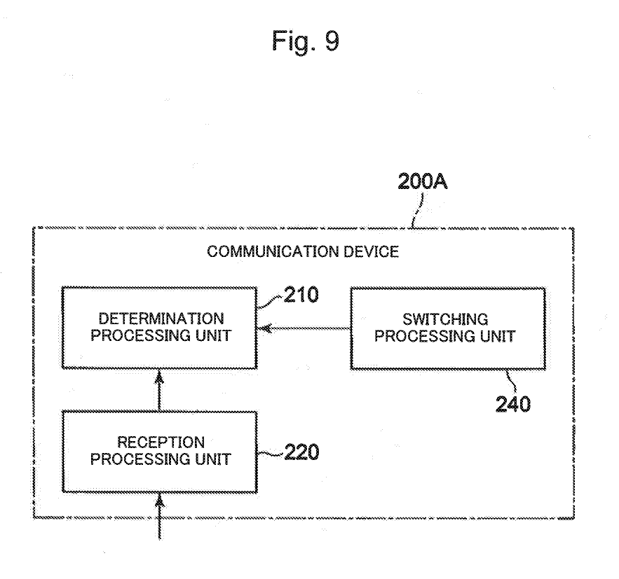

FIG. 9 is a block diagram illustrating a communication device 200A according to a fifth example embodiment of the present invention.

The illustrated communication device 200A has a configuration similar to that of the communication device 200 illustrated in FIG. 6 except for further including a switching processing unit 240, and operates similarly. Accordingly, a component having a function similar to that of the communication device 200 illustrated in FIG. 6 is given a same reference sign. For simplification of description, only a difference from the communication device 200 in FIG. 6 will be described below.

The switching processing unit 240 has a configuration similar to that of the switching processing unit 140 used by the communication device 100A illustrated in FIG. 8, and operates similarly. Accordingly, description of the switching processing unit 240 is omitted for simplification of description.

The communication device 200A according to the fifth example embodiment of the present invention with such a configuration provides an effect that an information delivery time can be shortened. The reason is that a delivery location is changed in consideration of a communication environment such as a travel time and a residence time.

### Sixth Example Embodiment

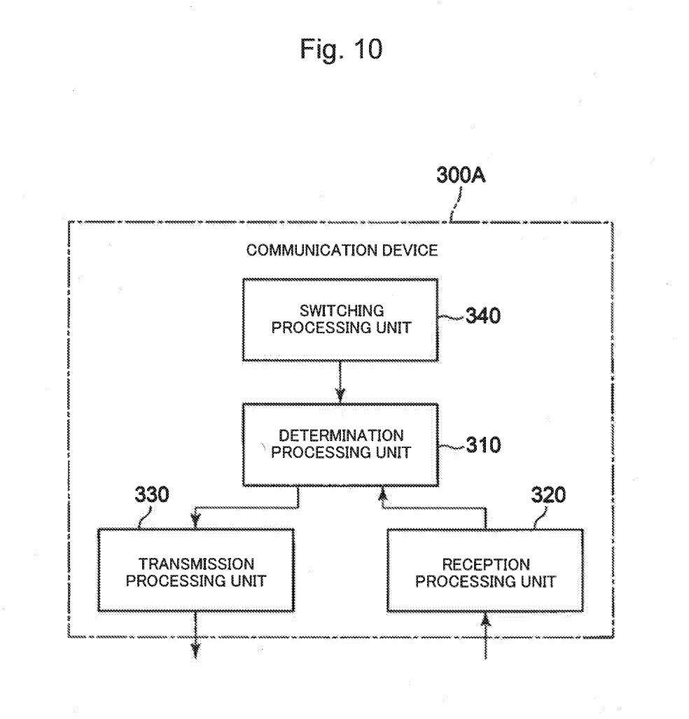

FIG. 10 is a block diagram illustrating a communication device 300A according to a sixth example embodiment of the present invention.

The illustrated communication device 300A has a configuration similar to that of the communication device 300 illustrated in FIG. 7 except for further including a switching processing unit 340, and operates similarly. Accordingly, a component having a function similar to that of the communication device 300 illustrated in FIG. 7 is given a same reference sign. For simplification of description, only a difference from the communication device 300 in FIG. 7 will be described below.

The switching processing unit 340 has a configuration similar to that of the switching processing unit 140 used by the communication device 100A illustrated in FIG. 8, and operates similarly. Accordingly, description of the switching processing unit 340 is omitted for simplification of description.

The communication device 300A according to the sixth example embodiment of the present invention with such a configuration provides an effect that an information delivery time can be shortened. The reason is that a delivery location is changed in consideration of a communication environment such as a travel time and a residence time.

### Seventh Example Embodiment

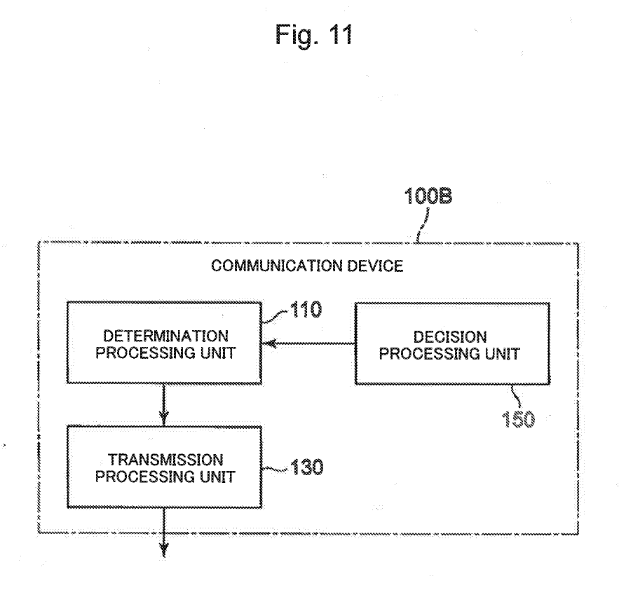

FIG. 11 is a block diagram illustrating a communication device 100B according to a seventh example embodiment of the present invention.

The illustrated communication device 100B has a configuration similar to that of the communication device 100 illustrated in FIG. 5 except for further including a decision processing unit 150, and operates similarly. Accordingly, a component having a function similar to that of the communication device 100 illustrated in FIG. 5 is given a same reference sign. For simplification of description, only a difference from the communication device 100 in FIG. 5 will be described below.

The decision processing unit 150 calculates a replication location and records the calculation result in the determination processing unit 110 as the aforementioned delivery location information. A method of calculating a replication location in the decision processing unit 150 will be described in detail later.

The communication device 100B may further include the switching processing unit 140 as illustrated in FIG. 8.

The communication device 100A according to the seventh example embodiment of the present invention with such a configuration provides an effect that an information delivery time can be shortened. The reason is that a second time T(2) can be shortened by not specifying a logically or physically distant route as a replication location.

### Eighth Example Embodiment

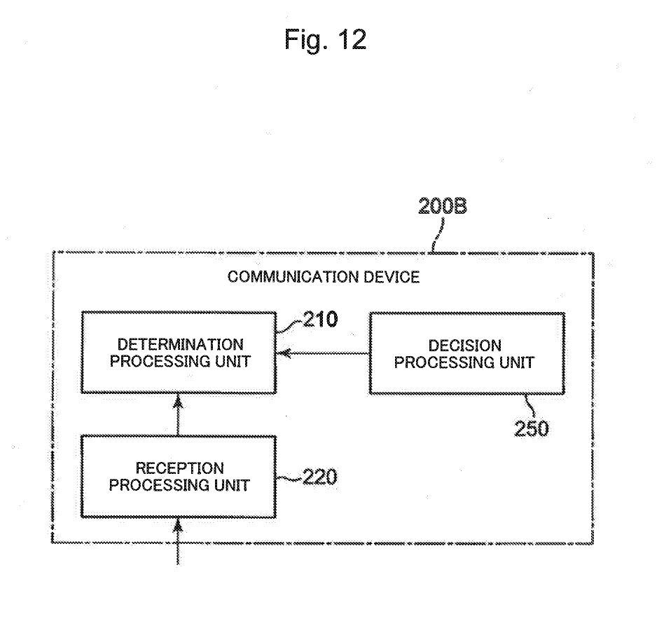

FIG. 12 is a block diagram illustrating a communication device 200B according to an eighth example embodiment of the present invention.

The illustrated communication device 200B has a configuration similar to that of the communication device 200 illustrated in FIG. 6 except for further including a decision processing unit 250, and operates similarly. Accordingly, a component having a function similar to that of the communication device 200 illustrated in FIG. 6 is given a same reference sign. For simplification of description, only a difference from the communication device 200 in FIG. 6 will be described below.

The decision processing unit 250 has a configuration similar to that of the decision processing unit 150 used by the communication device 100B illustrated in FIG. 11, and operates similarly. Accordingly, description of the decision processing unit 250 is omitted for simplification of description.

The communication device 200B may further include the switching processing unit 240 as illustrated in FIG. 9.

The communication device 200B according to the eighth example embodiment of the present invention with such a configuration provides an effect that an information delivery time can be shortened. The reason is that a second time T(2) can be shortened by not specifying a logically or physically distant route as a replication location.

### Ninth Example Embodiment

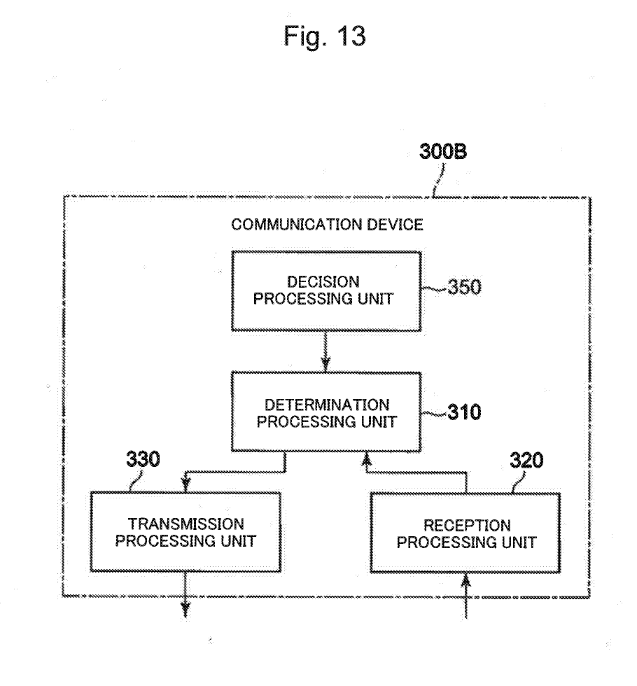

FIG. 13 is a block diagram illustrating a communication device 300B according to a ninth example embodiment of the present invention.

The illustrated communication device 300B has a configuration similar to that of the communication device 300 illustrated in FIG. 7 except for further including a decision processing unit 350, and operates similarly. Accordingly, a component having a function similar to that of the communication device 300 illustrated in FIG. 7 is given a same reference sign. For simplification of description, only a difference from the communication device 300 in FIG. 7 will be described below.

The decision processing unit 350 has a configuration similar to that of the decision processing unit 150 used by the communication device 100B illustrated in FIG. 11, and operates similarly. Accordingly, description of the decision processing unit 350 is omitted for simplification of description.

The communication device 300B may further include the switching processing unit 340 as illustrated in FIG. 10.

The communication device 300B according to the ninth example embodiment of the present invention with such a configuration provides an effect that an information delivery time can be shortened. The reason is that a second time T(2) can be shortened by not specifying a logically or physically distant route as a replication location.

### Tenth Example Embodiment

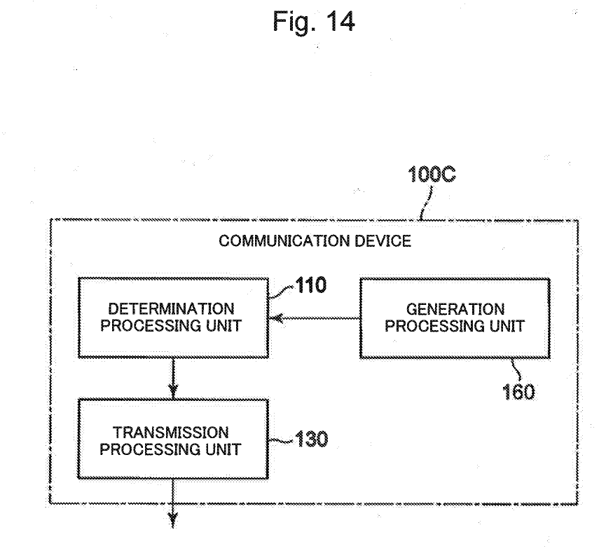

FIG. 14 is a block diagram illustrating a communication device 100C according to a tenth example embodiment of the present invention.

The illustrated communication device 100C has a configuration similar to that of the communication device 100 illustrated in FIG. 5 except for further including a generation processing unit 160, and operates similarly. Accordingly, a component having a function similar to that of the communication device 100 illustrated in FIG. 5 is given a same reference sign. For simplification of description, only a difference from the communication device 100 in FIG. 5 will be described below.

The generation processing unit 160 generates the aforementioned delivery information by adding both or one of two types of information being delivery destination information indicating a delivery destination of information and source information (delivery source information) indicating a source (delivery source) of the information to a body of the information. The generated delivery information is supplied to the determination processing unit 110.

The communication device 100C may further include both or one of the switching processing unit 140 as illustrated in FIG. 8 and the decision processing unit 150 as illustrated in FIG. 11.

The communication device 100C according to the tenth example embodiment of the present invention with such a configuration provides an effect that an information delivery time can be shortened. The reason is that a location (delivery location) where a replicate of information is generated is determined based on a destination (delivery destination), and therefore there is no need for time to generate route information in a terminal. Consequently, a first time T(1) can be shortened.

### Eleventh Example Embodiment

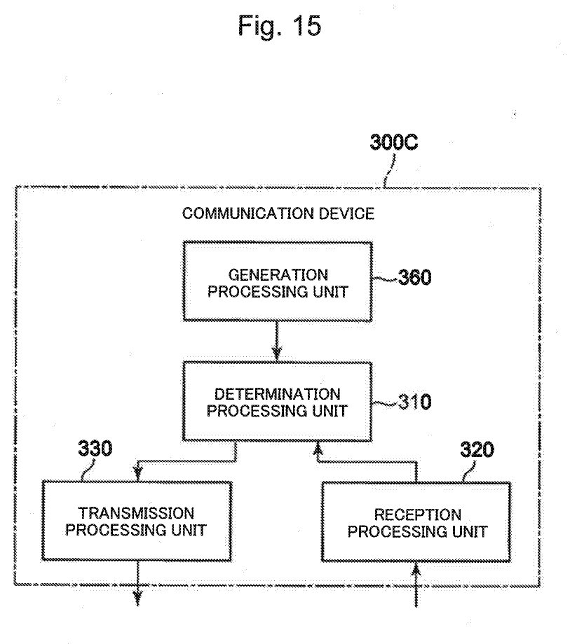

FIG. 15 is a block diagram illustrating a communication device 300C according to an eleventh example embodiment of the present invention.

The illustrated communication device 300C has a configuration similar to that of the communication device 300 illustrated in FIG. 7 except for further including a generation processing unit 360, and operates similarly. Accordingly, a component having a function similar to that of the communication device 300 illustrated in FIG. 7 is given a same reference sign. For simplification of description, only a difference from the communication device 300 in FIG. 7 will be described below.

The generation processing unit 360 has a configuration similar to that of the generation processing unit 160 used by the communication device 100C illustrated in FIG. 14, and operates similarly. Accordingly, description of the generation processing unit 360 is omitted for simplification of description.

The communication device 300C may further include both or one of the switching processing unit 340 as illustrated in FIG. 10 and the decision processing unit 350 as illustrated in FIG. 13.

The communication device 300C according to the tenth example embodiment of the present invention with such a configuration provides an effect that an information delivery time can be shortened. The reason is that a location (delivery location) where a replicate of information is generated is determined based on a destination (delivery destination), and therefore there is no need for time to generate route information in a terminal, and the information is not replicated at a location not contributing to transport of the information to the destination (delivery destination). Consequently, a first time T(1) and a third time T(3) can be shortened.

Next, a method of calculating a replication location in the decision processing unit 150 used by the communication device 100B illustrated in FIG. 11 will be described.

The decision processing unit 150 instructs generation of a replicate of information by adopting at least one of first to fifth specifying methods described below.

The first specifying method is a method of specifying so that a replicate of information is generated only for a delivery destination.

The second specifying method is a method of specifying so that a replicate of information is generated at every opportunity to communicate.

The third specifying method is a method of specifying so that a replicate of information is generated at a location existing on a route between a delivery destination of the information and a delivery source of the information.

The fourth specifying method is a method of setting a cost to a travel route between one location and another location, and specifying so that a replicate of information is generated based on a total cost of a travel route between a delivery destination of the information and a delivery source of the information.

The fifth specifying method is a method of specifying so that a replicate of information is generated based on a result of a vector operation on a locational direction vector connecting each location and a delivery destination, and a traveling direction vector indicating a traveling direction of a mobile terminal.

Note that a method of calculating a replication location in the decision processing units 250 and 350 respectively used by the communication devices 200B and 300B respectively illustrated in FIGS. 12 and 13 is a similar method.

The aforementioned third specifying method determines whether or not a travel route exists between one location and another location by adopting one of first to third determination methods described below.

The first determination method is a method of determining presence or absence of a travel route, based on a travel count of a mobile terminal traveling between one location and another location.

The second determination method is a method of determining presence or absence of a travel route, based on a travel probability of a certain terminal traveling to another location.

The third determination method is a method of determining presence or absence of a travel route, based on the aforementioned travel count and the aforementioned travel probability.

Further, the aforementioned fourth specifying method determines the aforementioned cost to be set, based on at least one factor of a physical distance between one location and another location, a stochastic value, and a travel frequency of a mobile terminal.

Referring to drawings, examples of the present invention will be described in detail below.

### Example 1

First, referring to drawings, a first example of the present invention will be described in detail.

The first example of the present invention relates to an information delivery method or an information replication method for promptly delivering information to a destination, a location, and a terminal by inter-terminal communication. The information replication method according to the first example of the present invention features determination of a location where a replicate of information is generated, based on a destination (delivery destination of information), and generation of a replicate of information only in a terminal encountered at the location. The first example decides whether or not to replicate information upon transmission.

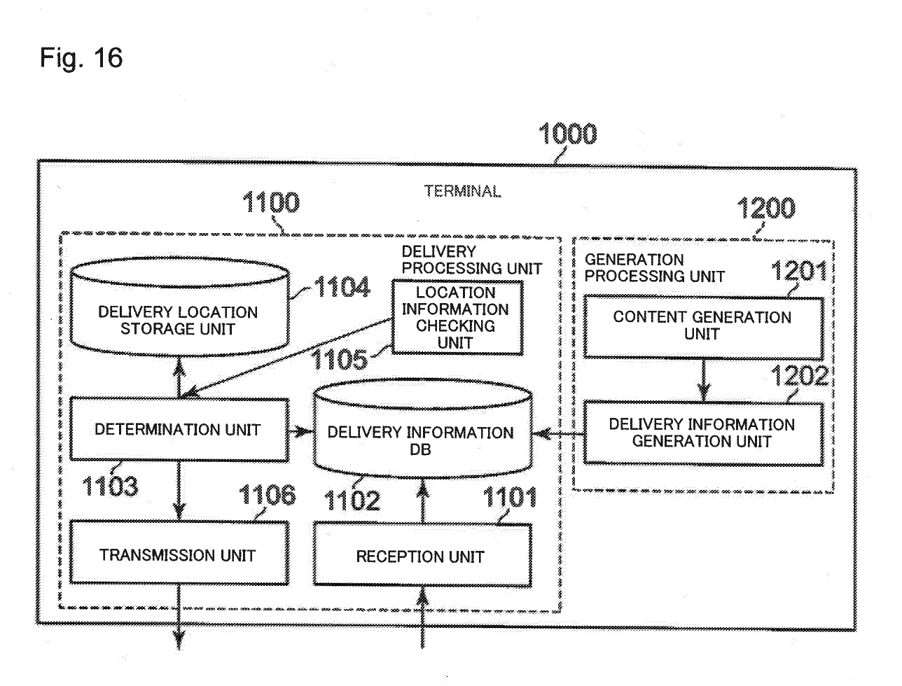

FIG. 16 is a block diagram illustrating a configuration of a terminal (communication device) 1000 according to the first example of the present invention. The illustrated terminal (communication device) 1000 is used as a mobile terminal Mj or a fixed terminal Fi constituting the information delivery system illustrated in FIG. 1.

The terminal (communication device) 1000 according to the first example includes a delivery processing unit 1100 responsible for a function of receiving information from another terminal and a function of transmitting information to another terminal, and a generation processing unit 1200 generating information.

The generation processing unit 1200 includes a content generation unit 1201 and a delivery information generation unit 1202. Generation processing in the generation processing unit 1200 aims at generating an information form to be handled by the first example of the present invention after a content to be transmitted is generated, and registering the information form in a database for delivery (unillustrated). Processing details of each unit in the generation processing unit 1200 will be described below.

The content generation unit 1201 generates information (content) to be transmitted to another terminal. The information (content) may have any content being information generated by a common application, such as text (e.g. email), voice, and an image. After generating a content, the content generation unit 1201 notifies the generated content to the delivery information generation unit 1202.

When receiving a content from the content generation unit 1201, the delivery information generation unit 1202 adds information (destination information) indicating a location (destination) where the information (content) is to be delivered, to the content body. The destination information may be statically held in the terminal 1000 or may be in such a form that an application (unillustrated) requests destination information to a user concurrently with generation of the content body.

In the first example of the present invention, information obtained by combining the content body with the destination location information is defined as delivery information.

After generating delivery information, the delivery information generation unit 1202 registers the generated delivery information in a delivery information database (hereinafter referred to as a “delivery information DB”) 1102 (to be described later) in the delivery processing unit 1100.

The delivery processing unit 1100 includes a reception unit 1101, a delivery information DB 1102, a determination unit 1103, a delivery location storage unit 1104, a location information checking unit 1105, and a transmission unit 1106. Delivery processing in the delivery processing unit 1100 is responsible for reception processing of delivery information and transmission processing of delivery information. The reception processing replicates information from another terminal and delivery information from the generation processing unit 1200 to the terminal 1000. The transmission processing searches for delivery information specifying a present moment as a replication point, based on positional information of the terminal 1000, and transmits the delivery information to another terminal. Processing details of each unit in the delivery processing unit 1100 will be described below.

When the terminal 1000 encounters another terminal, the reception unit 1101 receives delivery information transmitted by the another terminal. The reception unit 1101 registers the received information in the information delivery DB 1102.

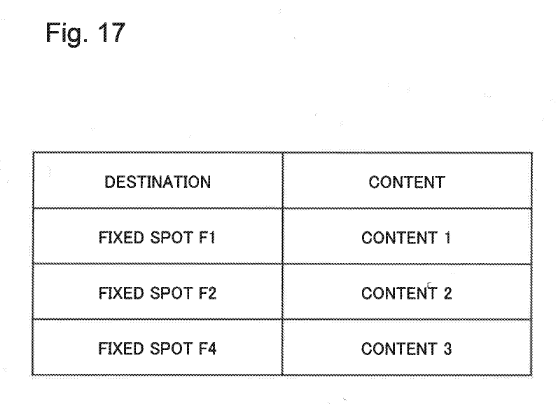

The delivery information DB 1102 is a database storing delivery information. As illustrated in FIG. 17, delivery information being separated into destination information and a content body is registered in the database.

Accordingly, a combination of the reception unit 1101 and the delivery information DB 1102 operates as a reception processing unit (1101, 1102) receiving delivery information.

The determination unit 1103 functions in such a way to check a present location of the terminal 1000, grasp a destination specifying the present location as a relay location, and determine as the present moment's delivery information whose grasped destination is matched a destination (delivery destination) of a delivery information to be actually delivered.

Specifically, first, the determination unit 1103 checks the location information checking unit 1105 for location information of the terminal 1000 at a present moment, periodically or upon occurrence of an event. Next, based on the checked location information, the determination unit 1103 makes an inquiry to the delivery location storage unit 1104 and identifies destination information specifying the present location as a delivery relay location. Finally, the determination unit 1103 searches the delivery information DB 1102 with each piece of the obtained destination information as a key and identifies delivery information with a destination matching the destination of the delivery information.

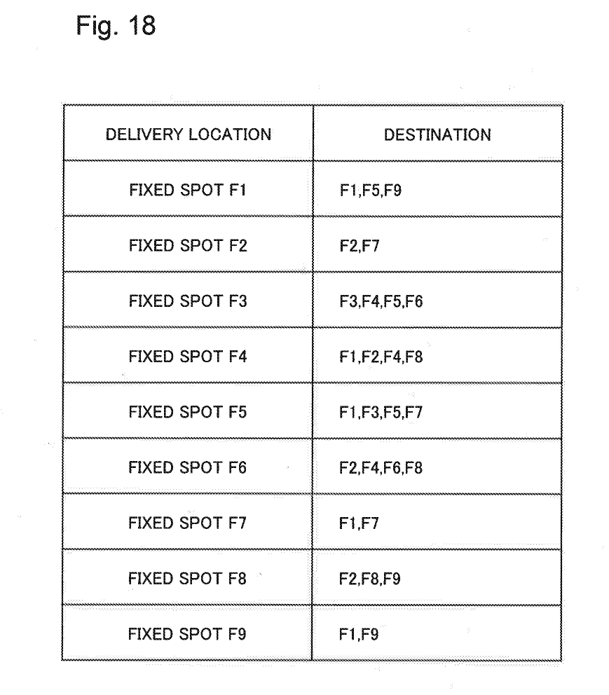

As an example, a state in which delivery information as indicated in FIG. 17 is registered in the delivery information DB 1102, and delivery location information as indicated in FIG. 18 is registered in the delivery location storage unit 1104 is assumed.

It is assumed here that, as a result of the determination unit 1103 checking the location information checking unit 1105 for a present location of the terminal 1000, the present location is a fixed spot F3. Based on the result, the determination unit 1103 searches the delivery location storage unit 1104 in which the delivery location information indicated in FIG. 18 is registered for a destination specifying the fixed spot F3 as a delivery location. The determination unit 1103 obtains destinations F3, F4, F5, and F6 from the search result.

Next, the determination unit 1103 searches the delivery information DB 1102 in which the delivery information indicated in FIG. 17 is registered for contents specifying F3, F4, F5, and F6 as destinations, respectively. In this case, the determination unit 1103 obtains only a “content 3” as a search result. Consequently, in this example, only delivery information (fixed spot F4, content 3) is delivered at the fixed spot F3.

The delivery location storage unit 1104 is a database storing delivery location information indicating a delivery location. By specifying a delivery location, the delivery location storage unit 1104 is able to identify destination information specifying the delivery location as a delivery relay location. As an example of the delivery location information, delivery locations and destination information, as indicated in FIG. 18, are registered in the delivery location storage unit 1104. However, various forms may be provided as long as a correspondence between a delivery location and a destination can be established.

The delivery location storage unit 1104 does not necessarily take a form of a database, and, for example, a function by which a delivery location can be identified from destination information may be used. Specifically, a hash function or the like takes destination information as an input value, and a delivery location as a return value. By preparing a plurality of hash functions, a plurality of delivery locations may also be prepared.

Further, even when taking a form of a database, the delivery location storage unit 1104 is not limited to the form in FIG. 18. For example, the delivery location storage unit 1104 may take a form of a database returning a delivery location with a destination as a primary key.

The location information checking unit 1105 records location information of the terminal 1000 and notifies the location information of the terminal 1000 when receiving an inquiry from another processing unit. When inquired about a present location by the determination unit 1103, the location information checking unit 1105 according to the first example returns information recorded therein to the determination unit 1103.

The location information, registered in the location information checking unit 1105, is a name of a location geographically specified in the system instead of information such as latitude and longitude itself. An example of a definition method is to return a zip code such as 673-0877 (the zip code of the Akashi Municipal Planetarium) as location information with respect to 135 degrees 00 minute 05.3 second east longitude and 34 degrees 38 minutes 57.8 seconds north latitude (the location of the Akashi Municipal Planetarium). The location information checking unit 1105 may use various methods such as grasping location information of the terminal 1000 by a global positioning system (GPS) in real time, recording a location indicated by a user on a map, and statically holding information in a case of a fixed terminal.

Accordingly, a combination of the delivery information DB 1102, the determination unit 1103, the delivery location storage unit 1104, and the location information checking unit 1105 operates as a determination processing unit (1102, 1103, 1104, 1105) determining whether or not to permit delivery of delivery information, based on a delivery destination of the delivery information, location information of the terminal 1000 at a present moment, and delivery location information associating a delivery destination with a replication destination.

When the terminal 1000 encounters another terminal, the transmission unit 1106 delivers information instructed by the determination unit 1103 to transmit, to the another terminal.

Accordingly, the transmission unit 1106 operates as a transmission processing unit (1106) transmitting delivery information to another terminal only when the determination processing unit (1102, 1103, 1104, 1105) determines to permit delivery.

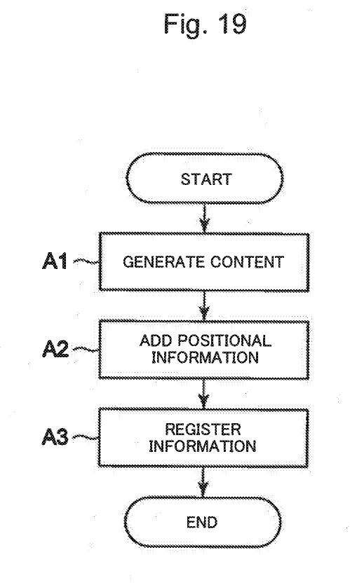

Next, referring to FIGS. 19, 20, and 21, processing flows in the terminal (communication device) 1000 according to the first example will be described.

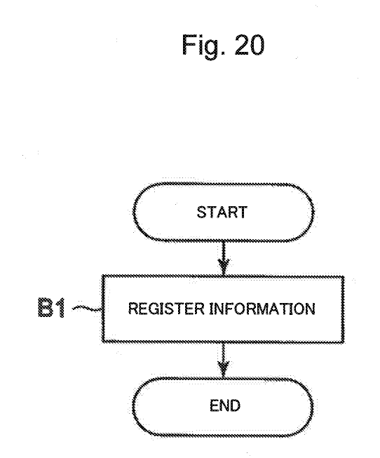

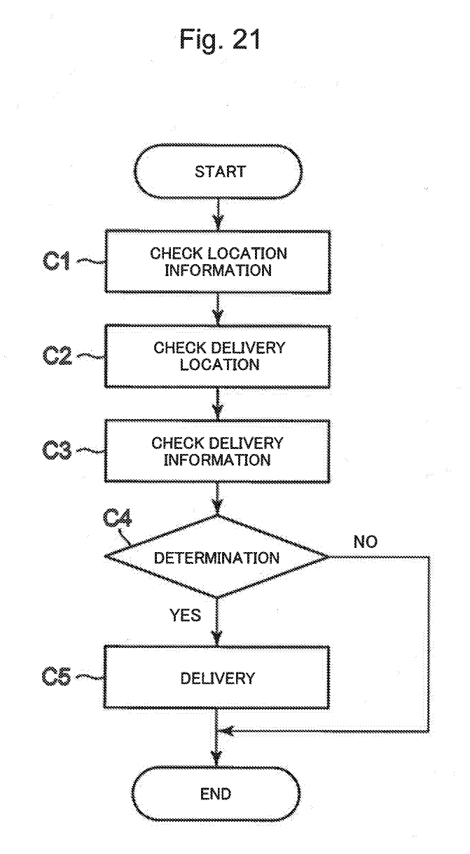

FIG. 19 is a flowchart illustrating a flow of generation processing in the generation processing unit 1200 when delivery information is generated in the terminal 1000. FIG. 20 is a flowchart illustrating a flow of reception processing in the delivery processing unit 1100 when the terminal 1000 encounters another terminal and receives delivery information from the another terminal. FIG. 21 is a flowchart illustrating a flow of transmission processing in the delivery processing unit 1100 when the terminal 1000 encounters another terminal and transmits delivery information to the another terminal.

The generation processing in the generation processing unit 1200 in FIG. 19 is started when information is generated in the terminal 1000.

In processing A1, the content generation unit 1201 generates a content. The content generation unit 1202 generates information to be transmitted to another terminal. The information may have any content being information generated by a common application, such as text (e.g. email), voice, and an image. After generating a content, the content generation unit 1202 passes the content to the delivery information generation unit 1202 and proceeds to processing A2.

In the processing A2, the delivery information generation unit 1202 adds location information (destination information) where the information is to be delivered, to the content body generated in the processing A1. The destination information may be statically held in the terminal 1000, or may be in such a form that an application requests destination information to a user concurrently with generation of the content body. As described above, in the first example of the present invention, information obtained by combining the content body with the destination location information is defined as delivery information. After generating the delivery information, the delivery information generation unit 1202 proceeds to processing A3.

In the processing A3, the delivery information generation unit 1202 registers the delivery information generated in the processing A2 in the delivery information DB 1120. When the registration processing is completed, the generation processing in the generation processing unit 1200 ends. Note that the delivery information registered in the delivery information DB 1120 includes a destination and a content body, as indicated in FIG. 17.

The reception processing in the delivery processing unit 1100 in FIG. 20 is started when the terminal 1000 encounters another terminal and receives information from another terminal.

In processing B1, the reception unit 1101 receives delivery information transmitted by another terminal and registers the delivery information in the delivery information DB 1102. When the reception unit 1101 registers the delivery information in the delivery information DB 1102, the reception processing ends.

The transmission processing in the delivery processing unit 1100 in FIG. 21 is started when the terminal 1000 encounters another terminal and transmits information to another terminal.

In processing C1, the determination unit 1103 inquires of the location information checking unit 1105 about present location information of the terminal 1000. When the location information is obtained, the determination unit 1103 proceeds to processing C2.

In the processing C2, the determination unit 1103 checks a delivery location, based on the location information obtained in the processing C1. Specifically, the determination unit 1103 searches the delivery location storage unit 1104 with the location information obtained in the processing C1 as a key and obtains destination information specifying the present location of the terminal 1000 as a relay location. When the destination information is obtained, the determination unit 1103 proceeds to processing C3.

In the processing C3, the determination unit 1103 checks delivery information, based on the destination information obtained in the processing C2. Specifically, the determination unit 1103 searches the delivery information DB 1102 with the destination obtained in the processing C2 as a key and obtains delivery information specifying the location obtained in the processing C2 as a destination, out of the entire delivery information. When the delivery information is obtained, the determination unit 1103 proceeds to processing C4.

In the processing C4, the determination unit 1103 determines whether or not to actually deliver each piece of delivery information. Specifically, when the delivery information obtained in the processing C3 is a delivery candidate, and another terminal being a transmission target at the time point exists, the determination unit 1103 determines to deliver the delivery information.

In the description above, the transmission processing has been described to be started when the terminal 1000 encounters another terminal and transmits information to another terminal. However, it is possible to always perform calculation in the processing C1 to the processing C3, regardless of an encounter with another terminal, and add a case of encountering another terminal to a transmission condition in the condition in the processing C4.

The process is proceeded to processing C5 when determining to “deliver,” and ends the transmission processing when determining “not to deliver.”

In the processing C5, the transmission unit 1106 actually delivers the delivery information to another terminal.

While a description of the first example has been that every terminal includes the generation processing unit 1200, the transmission processing unit (1106), and the reception processing unit (1101, 1102), a content generation terminal and a content relay terminal may be separated. In that case, when the content generation terminal transmits delivery information composed of a destination and a content body to the relay terminal, the relay terminal has only to include the transmission processing unit (1106) and the reception processing unit (1101, 1102).

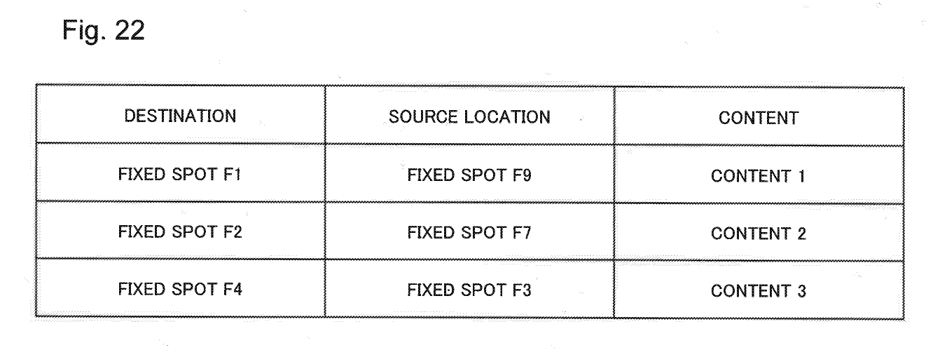

Further, with regard to delivery information, the first example assumes that delivery information is defined as a combination of a destination and a content body, as indicated in FIG. 17, and the delivery information is registered in the delivery information DB 1102. However, the delivery information may be defined as a destination and a content body added with a source location (delivery source) of information, as indicated in FIG. 22. This case may be handled by the delivery information generation unit 1202 inquiring of the location information checking unit 1105 about a present location of the terminal 1000 and adding the present location and the destination to the content body.

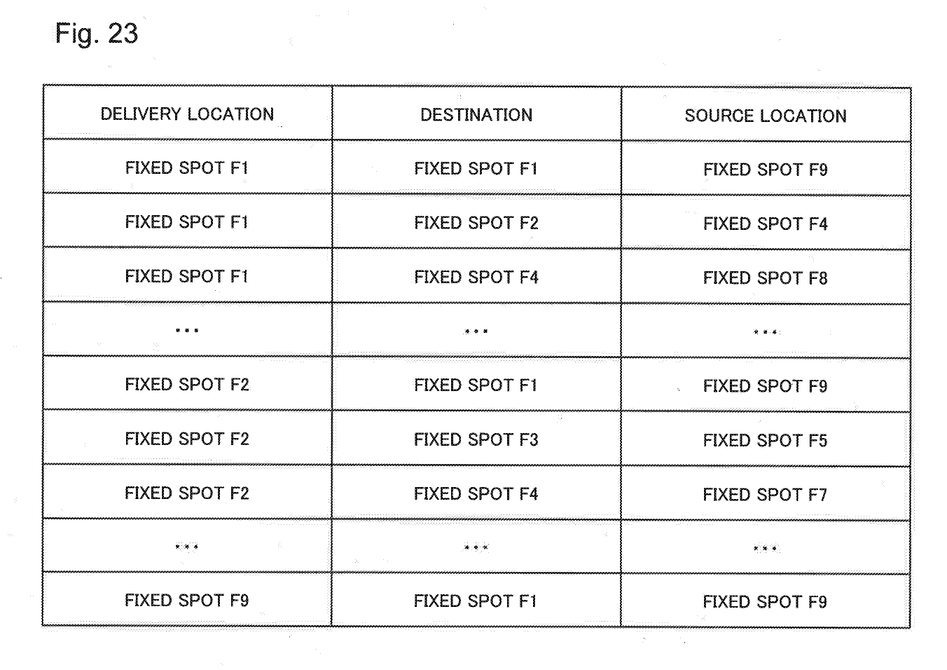

Similarly, with regard to delivery location information, the first example assumes that the delivery location information is defined as a delivery location grouped with a destination, as indicated in FIG. 18, and the delivery location information is stored in the delivery location storage unit 1104. However, the delivery location information may be defined as a delivery location, a destination (delivery destination), and a source location (delivery source) grouped together, as indicated in FIG. 23. In this case, when the delivery location storage unit 1104 is searched for a delivery location, a group of a destination and a source location is obtained as a result. Then, based on the result, the determination unit 1103 searches the delivery information DB 1102 in which delivery information as indicated in FIG. 22 is registered and finds a content related to a group of a source location and a destination, the group being related to the delivery destination of the information being the present location of the terminal 1000.

While a content body is identified after a destination is determined from a delivery location by searching the delivery location storage unit 1104 and the delivery information DB 1102 in this order in the first example, the order may be changed.

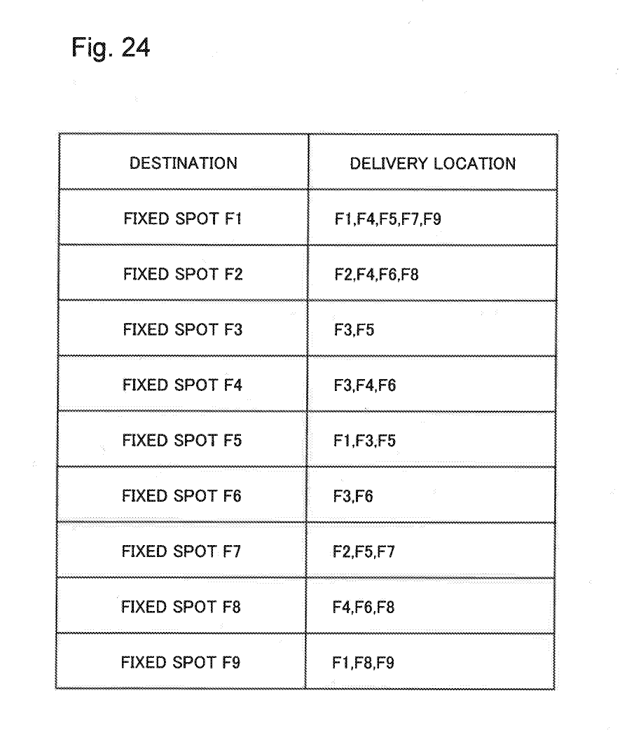

In that case, first, the determination unit 1103 refers to the delivery information DB 1102 in which delivery information as indicated in FIG. 17 is registered and searches for a destination group of held contents. In the example in FIG. 17, the group includes fixed spots F1, F2, and F4. Subsequently, referring to the result, the determination unit 1103 searches the delivery location storage unit 1104 for a delivery location related to the fixed spots F1, F2, and F4 as destinations. In this case, a database recording delivery locations with a destination being a primary key, as illustrated in FIG. 24, is often used as the delivery location storage unit 1104.

In the example in FIG. 24, a search result for the destination F1 is delivery locations F1, F4, F5, F7, and F9, a search result for the destination F2 is delivery locations F2, F4, F6, and F8, and a search result for the destination F4 is delivery locations F3, F4, and F6. When the search result matches a present spot of the terminal 1000, the determination unit 1103 determines to send target delivery information. For example, when the present spot of the terminal 1000 is F4, all of contents 1, 2, and 3 respectively related to the destination F1, the destination F2, and the destination F4 are transmission targets. On the other hand, when the present spot of the terminal 1000 is F1, only the content 1 related to the destination F1 is a transmission target.

While a description of the first example has been that the delivery information DB 1102 includes a table as illustrated in FIG. 17, any form may be used as long as the form is capable of identifying a destination of each content.

Similarly, while a description of the first example has been that the delivery location storage unit 1104 includes a table as illustrated in FIG. 18, any form may be used as long as a correspondence between a delivery location and a destination can be established.

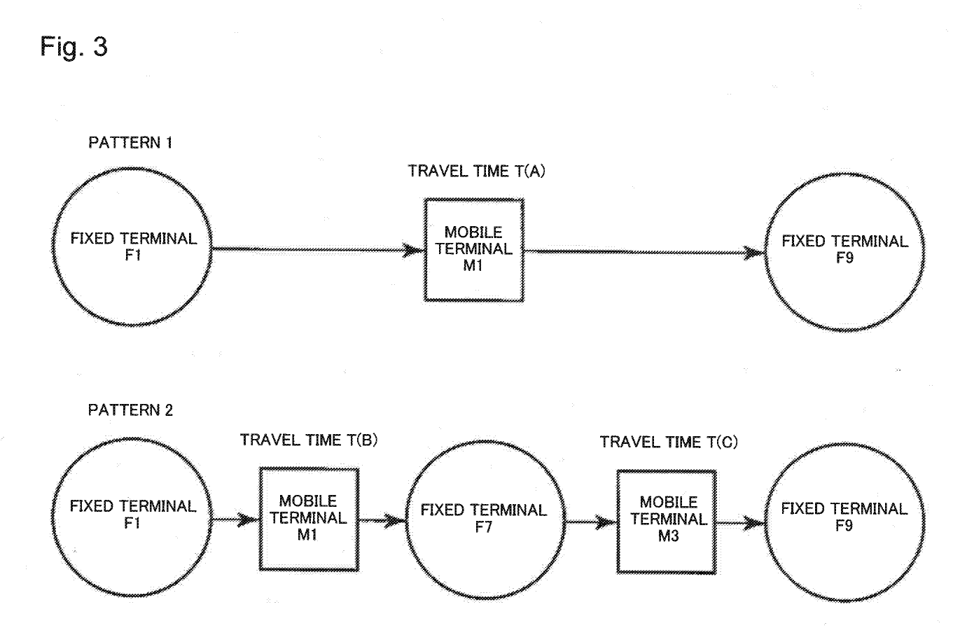

A description of the first example has been that the terminal (communication device) 1000 includes a mobile terminal Mj or a fixed terminal Fi, taking a case that a specific terminal has specific location information in the information delivery systems illustrated in FIGS. 1, 2, and 3 as an example. The reason is an intention to simply describe a mechanism to determine whether or not to permit delivery, based on location information (a mechanism to determine whether or not to permit communication, based on presence or absence at the location instead of a terminal identification [ID]).

However, it is sufficient for an information delivery system to which the terminal (communication device) 1000 according to the first example is applied to be a system in which a terminal capable of communicating delivery information when arriving at a fixed location exists, and a terminal capable of communicating delivery information at a specific location is not necessarily a specific terminal. Examples of such an information delivery system may include forms such as building an ad hoc network using a plurality of mobile terminals in a fixed spot, and a plurality of terminals holding, in a distributed manner, location information stored in a fixed spot as is a case with an anchor zone in NPL 4. In NPL 4, under a condition that p>0 is met in equation (2), even when a mobile terminal does not continue to stay at a location and is always traveling, location information is stored in a mobile terminal existing at the location and the information can be acquired at the location.

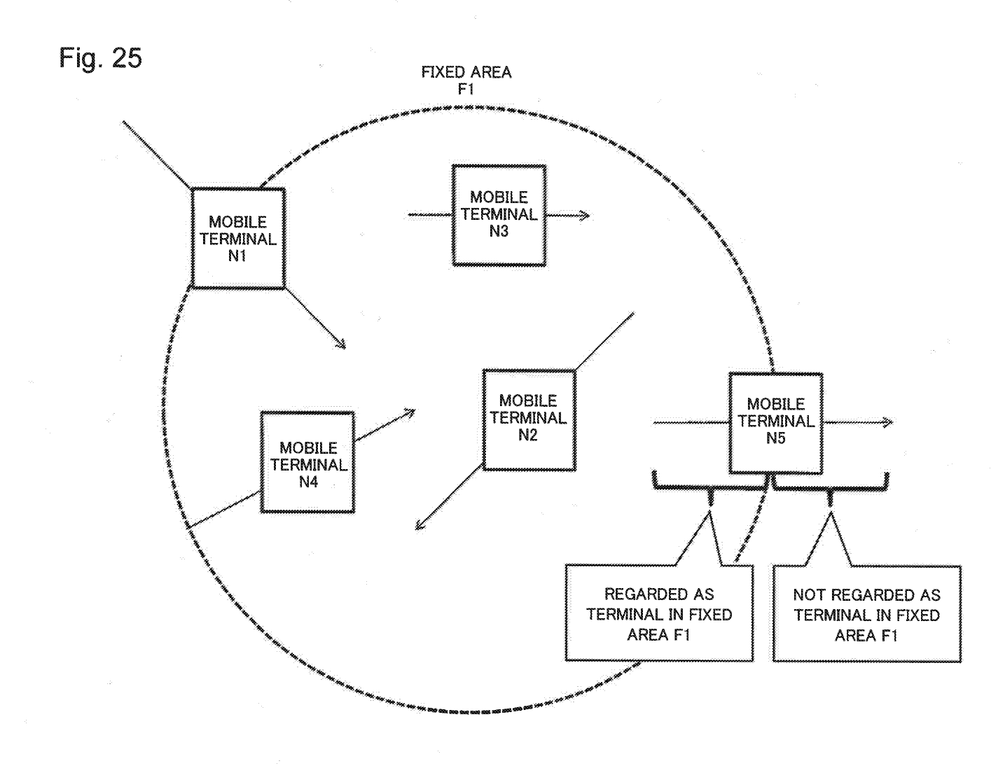

FIG. 25 is a system configuration diagram illustrating another information delivery system (ad hoc network) to which the terminal (communication device) 1000 illustrated in FIG. 16 is applicable. The information delivery system (ad hoc network) is a system in which a plurality of mobile terminals exist in one fixed area. The illustrated information delivery system (ad hoc network) illustrates an example of first to fifth mobile terminals N1 to N5 existing in a fixed area F1 at the instant.

In the information delivery system (ad hoc network) illustrated in FIG. 25, the fifth mobile terminal N5 is traveling from inside the fixed area F1 to outside the fixed area F1. When the fifth mobile terminal N5 exists inside the fixed area F1, the fifth mobile terminal N5 is a replication target of information being a delivery target in the fixed area F1. When the fifth mobile terminal N5 is outside the fixed area F1, the fifth mobile terminal N5 is not a replication target of information being a delivery target in the fixed area F1.

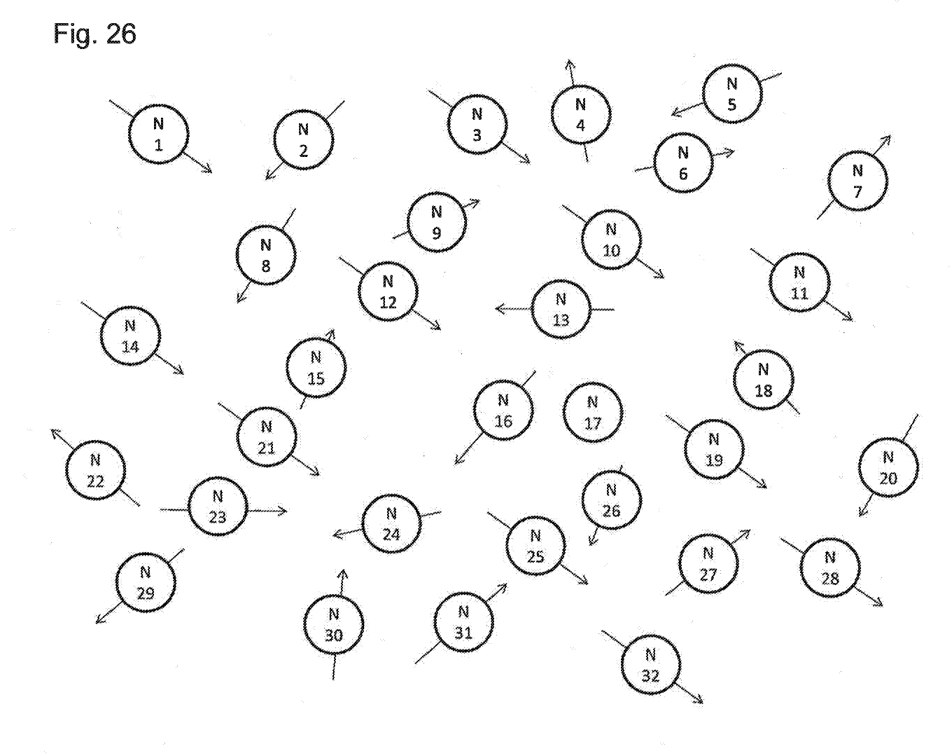

FIG. 26 is a system configuration diagram illustrating yet another information delivery system to which the terminal (communication device) 1000 illustrated in FIG. 16 is applicable. The illustrated information delivery system is a system entirely configured with a plurality of mobile terminals. In the illustrated example, the information delivery system includes first to thirty-second mobile terminals N1 to N32.

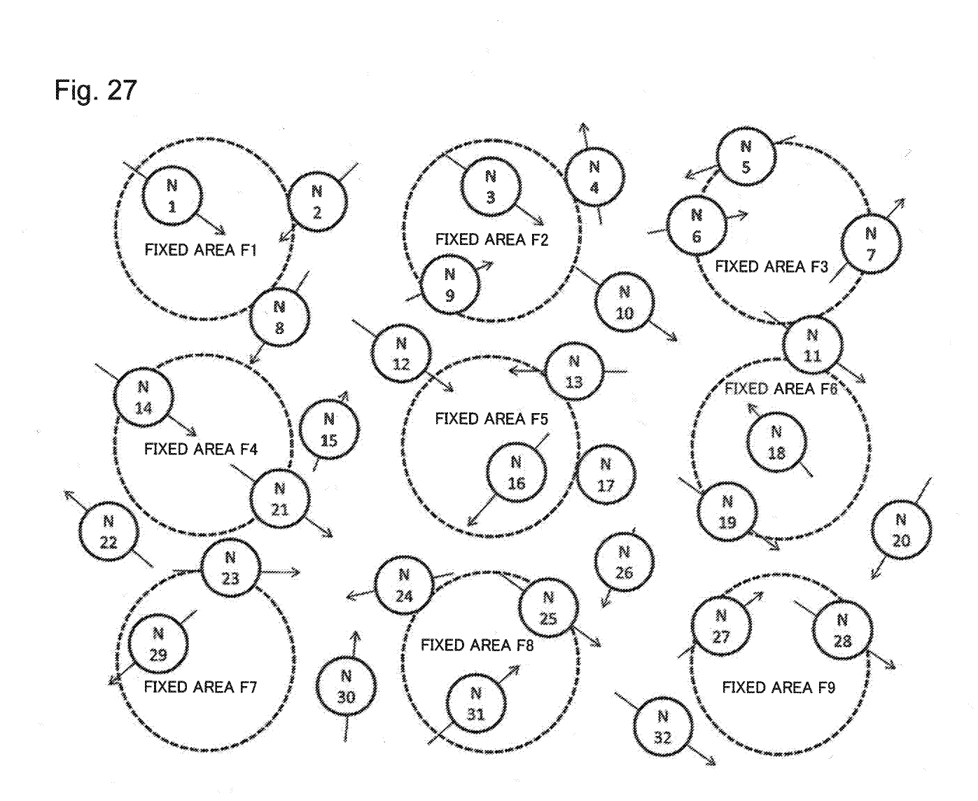

Even in the case of the information delivery system illustrated in FIG. 26, mobile terminals existing in each fixed area at an instant may be virtually regarded as fixed terminals in the case of the information delivery system in FIG. 1, as illustrated in FIG. 27. In this case, terminals constituting each fixed area (fixed terminal) change with time.

Similarly to the information delivery system illustrated in FIG. 1, the information delivery system illustrated in FIG. 27 illustrates an example that first to ninth fixed areas F1 to F9 virtually exist. Since the first mobile terminal N1 exists in the first fixed area F1, the first mobile terminal N1 is virtually regarded as a first fixed terminal. Since the third and ninth mobile terminals N1 and N9 exist in the second fixed area F2, each of the third and ninth mobile terminals N1 and N9 is virtually regarded as a second fixed terminal. Since the fifth to seventh mobile terminals N5 to N7 exist in the third fixed area F3, each of the fifth to seventh mobile terminal N5 to N7 is virtually regarded as a third fixed terminal. Since the fourteenth and twenty-first mobile terminals N14 and N21 exist in the fourth fixed area F4, each of the fourteenth and twenty-first mobile terminals N14 and N21 is virtually regarded as a fourth fixed terminal. Since the sixteenth mobile terminal N16 exists in the fifth fixed area F5, the sixteenth mobile terminal N16 is virtually regarded as a fifth fixed terminal. Since the eighteenth and nineteenth mobile terminals N18 and N19 exist in the sixth fixed area F6, each of the eighteenth and nineteenth mobile terminals N18 and N19 is virtually regarded as a sixth fixed terminal. Since the twenty-ninth mobile terminal N29 exists in the seventh fixed area F7, the twenty-ninth terminal N29 is virtually regarded as a seventh fixed terminal. Since the twenty-fifth and thirty-first mobile terminals N25 and N31 exist in the eighth fixed area F8, each of the twenty-fifth and thirty-first mobile terminals N25 and N31 is virtually regarded as an eighth fixed terminal. Since the twenty-seventh and twenty-eighth mobile terminals N27 and N28 exist in the ninth fixed area F9, each of the twenty-seventh and twenty-eighth mobile terminals N27 and N28 is virtually regarded as a ninth fixed terminal.

With a mechanism to determine whether or not to permit delivery, based on location information, like the terminal (communication device) 1000 according to the first example of the present invention, an information delivery system can be provided by merely equipping the same mechanism on every terminal, without distinguishing a fixed terminal from a mobile terminal.

As is obvious from the description above, the terminal 1000 according to the first example of the present invention is able to shorten an information delivery time. The reason is that a location (delivery location) where a replicate of delivery information is generated is determined based on a destination (delivery destination), and a replicate of the delivery information is generated only in a terminal encountered at the delivery location. More specifically, in the terminal 1000 (information replication method) according to the first example of the present invention, when a mobile terminal Mj arrives at a fixed terminal Fi, information is replicated triggered by arrival of the mobile terminal Mj at the location, regardless of an attribute of the mobile terminal Mj such as whether or not a reaching probability is held therein. Accordingly, the first example of the present invention does not require time to generate route information in the terminal 1000 and is able to shorten a first time T(1).

### Example 2

Next, referring to drawings, a second example of the present invention will be described in detail.

The second example of the present invention relates to an information delivery method or an information replication method for promptly delivering information to a destination, a location, and a terminal by inter-terminal communication. The information replication method according to the second example of the present invention features determination of a delivery location where a replicate of delivery information is generated, based on a destination (information delivery destination), and generation of a replicate only in a terminal encountered at the delivery location. The second example decides whether or not to replicate information upon reception.

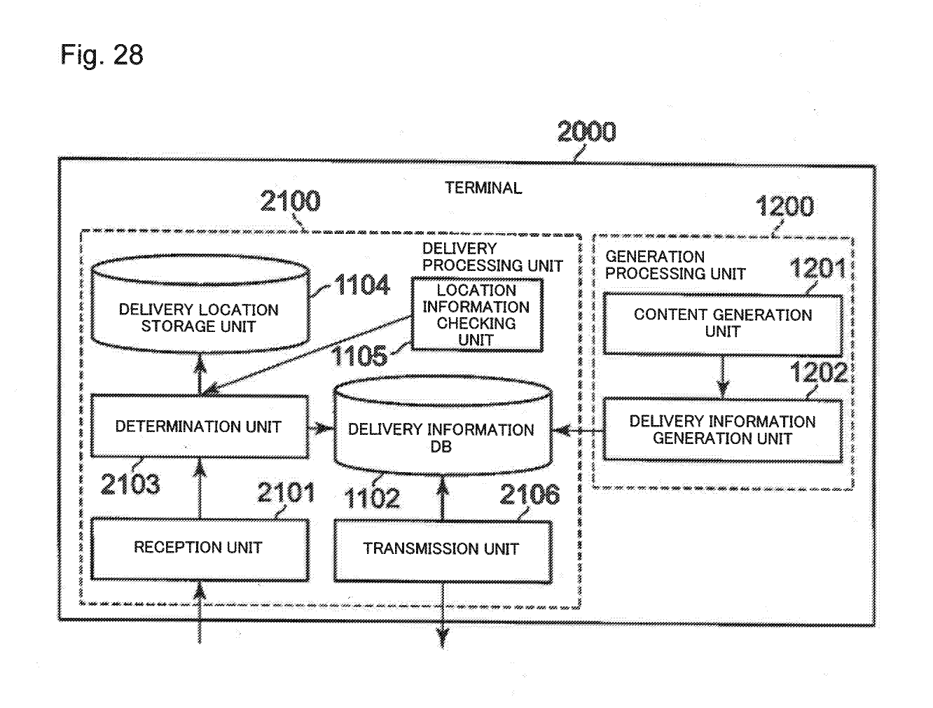

FIG. 28 is a block diagram illustrating a configuration of a terminal 2000 according to the second example of the present invention. The illustrated terminal (communication device) 2000 also is used as a mobile terminal Mj or a fixed terminal Fi constituting the information delivery system illustrated in FIG. 1, or is used as a mobile terminal constituting the information delivery system illustrated in FIG. 25 or 26.

The terminal 2000 according to the second example includes a delivery processing unit 2100 responsible for a function of receiving information from another terminal and a function of transmitting information to another terminal, and a generation processing unit 1200 generating information.

Processing performed by the generation processing unit 1200 generating information is identical to that performed by the generation processing unit 1200 according to the first example illustrated in FIG. 16, and therefore description thereof is omitted.

The delivery processing unit 2100 includes a reception unit 2101, a delivery information DB 1102, a determination unit 2103, a delivery location storage unit 1104, a location information checking unit 1105, and a transmission unit 2106.

Delivery processing in the delivery processing unit 2100 is responsible for reception processing and transmission processing of delivery information. The reception processing replicates information from another terminal and delivery information from the generation processing unit 1200 to the terminal 2000. The transmission processing searches for delivery information specifying a present moment of the terminal 2000 as a replication point, from positional information of the terminal 2000, and transmits the delivery information to another terminal. Processing details of each unit in the delivery processing unit 2100 will be described below.

Processing performed by the delivery information DB 1102, the delivery location storage unit 1104, and the location information checking unit 1105 is identical to that performed in the first example illustrated in FIG. 16, and therefore description thereof is omitted.

When the terminal 2000 encounters another terminal, the reception unit 2101 receives delivery information transmitted by another terminal. The reception unit 2101 passes the received delivery information to the determination unit 2103 in order to decide whether or not the received delivery information is really receivable.

The reception unit 2101 operates as a reception processing unit (2101) receiving delivery information from another terminal.

The determination unit 2103 checks a present location of the terminal 2000, grasps a destination specifying the present location as a relay location, and determines as the present moment's receivable delivery information whose grasped destination is matched a destination of a delivery information.

Specifically, first, the determination unit 2103 checks the location information checking unit 1105 for location information at the present moment, periodically or upon occurrence of an event. Next, based on the checked location information, the determination unit 2103 makes an inquiry to the delivery location storage unit 1104 and identifies destination information specifying the present location of the terminal 2000 as a delivery relay location. Finally, the determination unit 2103 checks a destination of the delivery information received by the reception unit 2101 with each piece of the obtained destination information as a key. When delivery information with a matching destination exists, the determination unit 2103 determines the delivery information to be receivable delivery information and registers the delivery information in the delivery information DB 1102.

Accordingly, a combination of the determination unit 2103, the delivery information DB 1102, the delivery location storage unit 1104, and the location information checking unit 1105 operates as a determination processing unit (2103, 1102, 1104, 1105) determining whether or not to permit import of delivery information received by the reception processing unit (2101), based on delivery destination information indicating a delivery destination of delivery information, location information indicating a location of the terminal 2000 at the present moment, and delivery location information indicating a delivery location associating a delivery destination with a replication destination.

When encountering another terminal, the transmission unit 2106 delivers delivery information registered in the delivery information DB 1102 to another device.

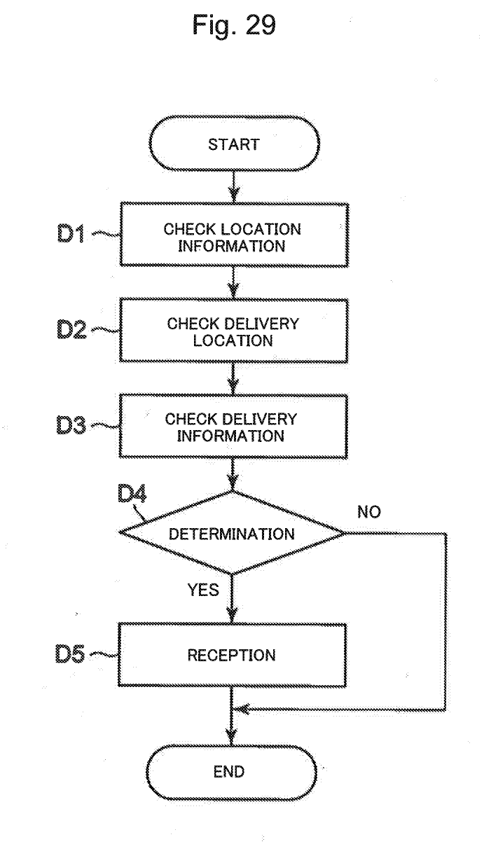

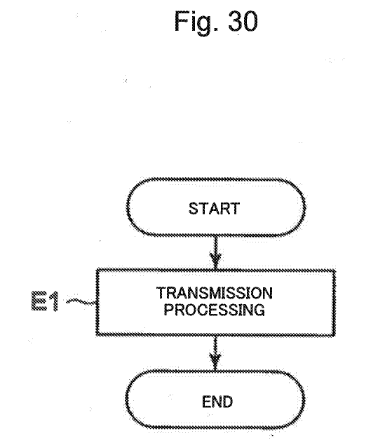

Next, referring to FIGS. 29 and 30, processing flows in the terminal 2000 according to the second example will be described.

A processing flow related to generation processing when generating information in the terminal 2000 according to the second example is identical to that in the first example, and therefore description thereof is omitted.

FIG. 29 is a flowchart illustrating a flow of reception processing in the delivery processing unit 2100 when the terminal 2000 encounters another terminal and receives information from the another terminal. FIG. 30 is a flowchart illustrating a flow of transmission processing in the delivery processing unit 2100 when the terminal 2000 encounters another terminal and transmits information to the another terminal.

The reception processing in the delivery processing unit 2100 in FIG. 29 is started when the terminal 2000 encounters another terminal and receives information from another terminal.

In processing D1, the determination unit 2103 inquires of the location information checking unit 1105 about present location information. When the location information is obtained, the determination unit 2103 proceeds to processing D2.

In the processing D2, based on the location information obtained in the processing D1, the determination unit 2103 checks delivery location. The determination unit 2103 searches the delivery location storage unit 1104 with the location information obtained in the processing D1 as a key and obtains destination information specifying the present location of the terminal 2000 as a relay location. When the destination information is obtained, the determination unit 2103 proceeds to processing D3.

In the processing D3, based on the destination information obtained in the processing D2, the determination unit 2103 checks the delivery information received by the reception unit 2101. The determination unit 2103 checks whether or not a destination of the received delivery information matches the destination obtained in the processing D2 and decides receiving only delivery information whose destination is matched. After the decision, the determination unit 2103 proceeds to processing D4.

In the processing D4, the determination unit 2103 determines whether or not to actually receive each piece of delivery information. The determination unit 2103 proceeds to processing D5 when determining to “receive,” and ends the reception processing when determining “not to receive.”

Specifically, the determination unit 2103 determines whether or not to permit reception as follows. The delivery information obtained in the processing D3 is a reception candidate. When determining that delivery information being a reception target exists, the determination unit 2103 proceeds to the processing D5. When determining that delivery information being a reception target does not exist, the determination unit 2103 ends the reception processing.

In the processing D5, the determination unit 2103 registers the delivery information determined to be a reception target in the processing D4, in the delivery information DB 1102.

The transmission processing in the delivery processing unit 2100 in FIG. 30 is started when the terminal 2000 encounters another terminal and transmits information to another terminal.

In processing E1, when encountering another terminal, the transmission unit 2106 delivers information registered in the delivery information DB 1102.

As is obvious from the description above, the terminal 2000 (information replication method) according to the second example of the present invention is able to shorten an information delivery time. The reason is as follows. Even when a mobile terminal Mj arrives at a fixed terminal Fi, the terminal 2000 according to the second example does not replicate information at a location not contributing to transport of the information to a destination (delivery destination). Consequently, the second example of the present invention does not replicate information at an unnecessary location and is able to shorten a third time T(3).

A determination of whether or not to generate a replicate of information is made upon transmission using the determination unit 1103 in the first example and upon reception using the determination unit 2103 in the second example. However, the determination unit 1103 and the determination unit 2103 may be concurrently included, and a determination of whether or not to replicate information may be added upon transmission and reception concurrently.

### Example 3

Next, referring to drawings, a third example of the present invention will be described in detail.

The third example of the present invention relates to an information delivery method or an information replication method for promptly delivering information to a destination, a location, and a terminal by inter-terminal communication. The information replication method according to the third example of the present invention features determination of a delivery location where a replicate of delivery information is generated, based on a destination (information delivery destination), and generation of a replicate only in a terminal encountered at the delivery location. The information replication method according to the third example features that a plurality of delivery location DBs exist inside, and which delivery location DB is to be adopted is determined by a communication environment. The communication environment is determined by a residence time and a travel time.

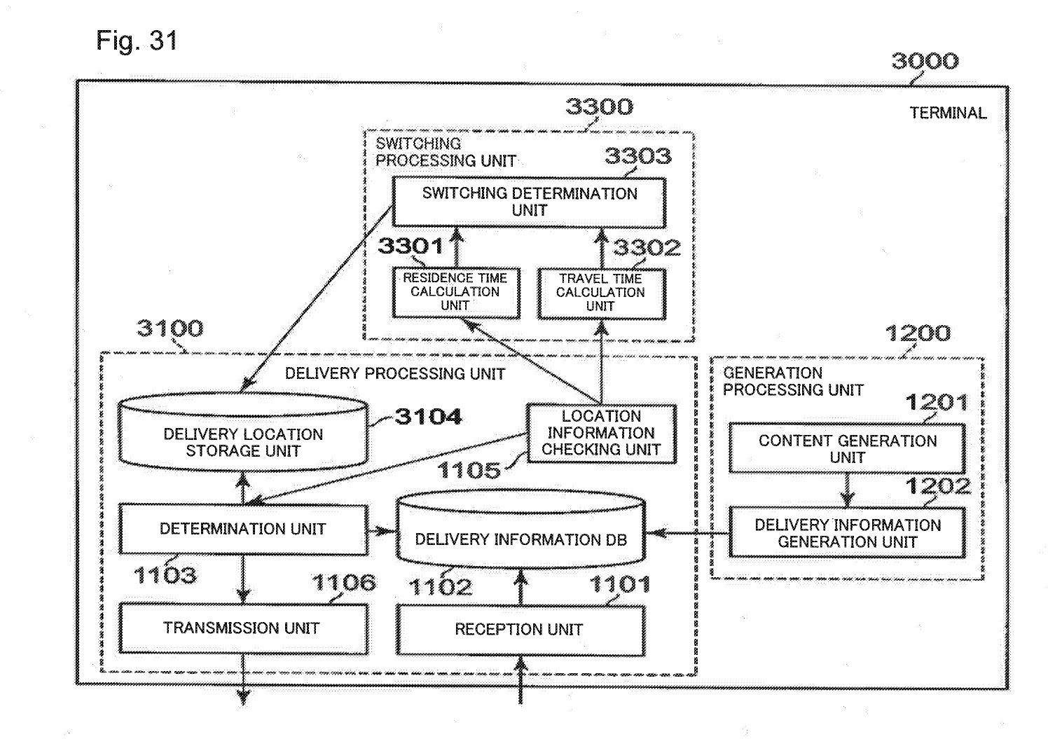

FIG. 31 is a block diagram illustrating a configuration of a terminal (communication device) 3000 according to the third example of the present invention. The illustrated terminal (communication device) 3000 also is used as a mobile terminal Mj or a fixed terminal Fi constituting the information delivery system illustrated in FIG. 1, or is used as a mobile terminal constituting the information delivery system illustrated in FIG. 25 or 26.

The terminal 3000 according to the third example includes a delivery processing unit 3100 responsible for a function of receiving information from another terminal and a function of transmitting information to another terminal, a generation processing unit 1200 generating information, and a switching processing unit 3300.

Processing performed by the generation processing unit 1200 generating information is identical to that performed in the first example illustrated in FIG. 16, and therefore description thereof is omitted.

The delivery processing unit 3100 includes a reception unit 1101, a delivery information DB 1102, a determination unit 1103, a delivery location storage unit 3104, a location information checking unit 1105, and a transmission unit 1106. Delivery processing in the delivery processing unit 3100 is responsible for reception processing of delivery information and transmission processing of delivery information. The reception processing replicates information from another terminal and delivery information from the generation processing unit 1200 to the terminal 3000. The transmission processing searches for delivery information specifying a present moment as a replication point, from positional information of the terminal 3000, and transmits the delivery information to another terminal. Processing details of each unit in the delivery processing unit 3100 will be described below.

Processing performed by the reception unit 1101, the delivery information DB 1102, the determination unit 1103, the location information checking unit 1105, and the transmission unit 1106 is identical to that performed in the first example illustrated in FIG. 16, and therefore description thereof is omitted.

The delivery location storage unit 3104 is a database storing delivery location information indicating a delivery location. Similarly to the aforementioned first example and second example, the delivery location storage unit 3104 is a mechanism for establishing a correspondence between a delivery location and a destination (delivery destination).

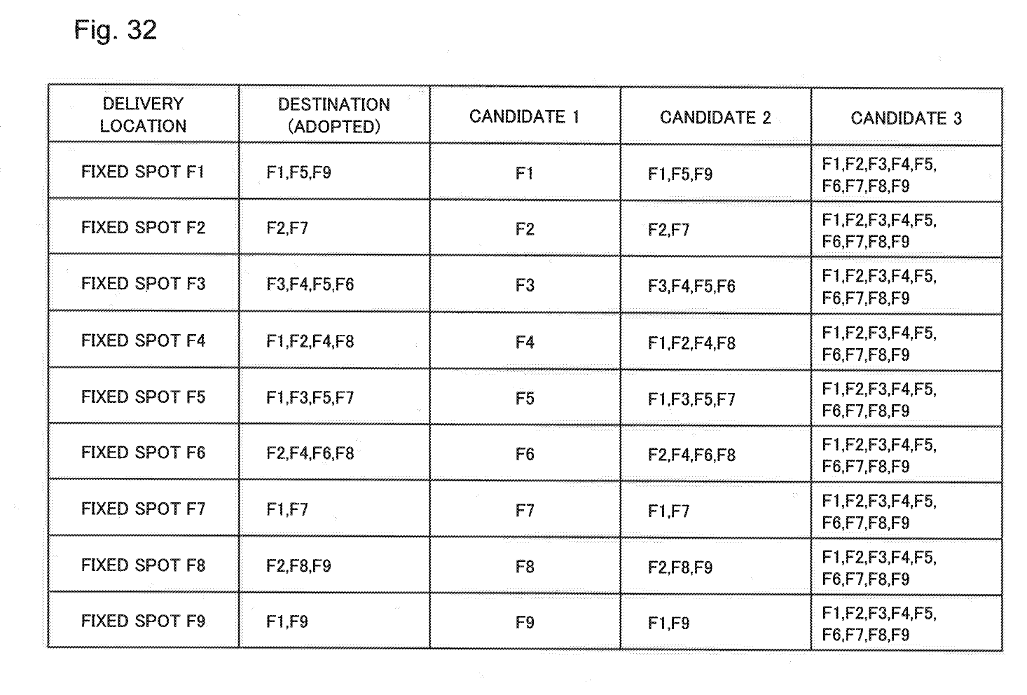

However, as illustrated in FIG. 32, a plurality of destination candidates exist for each delivery location in the delivery location storage unit 3104 according to the third example, and information to be adopted is selected from the candidates upon searching. In other words, the delivery location storage unit 3104 includes a plurality of delivery location DBs. When searched by another mechanism such as the determination unit 1103, the delivery location storage unit 3104 returns destination information being adopted, with a delivery location as a key. On the other hand, when instructed by the switching processing unit 3300, the delivery location storage unit 3104 determines which candidate is to be adopted out of a plurality of candidates and records the adopted information in a “destination (present).” In the example in FIG. 32, a candidate 2 is selected and information thereof is recorded in the “destination (adopted).”

The switching processing unit 3300 includes a residence time calculation unit 3301, a travel time calculation unit 3302, and a switching determination unit 3303. Switching processing in the switching processing unit 3300 monitors a delivery environment and determines which of a plurality of prepared delivery location databases is to be selected.

The residence time calculation unit 3301 calculates time during which a mobile terminal stays at a specified location. A method of periodically acquiring positional information by the location information checking unit 1105 and counting a residence time at a specific location may be cited as an example of residence time measurement.

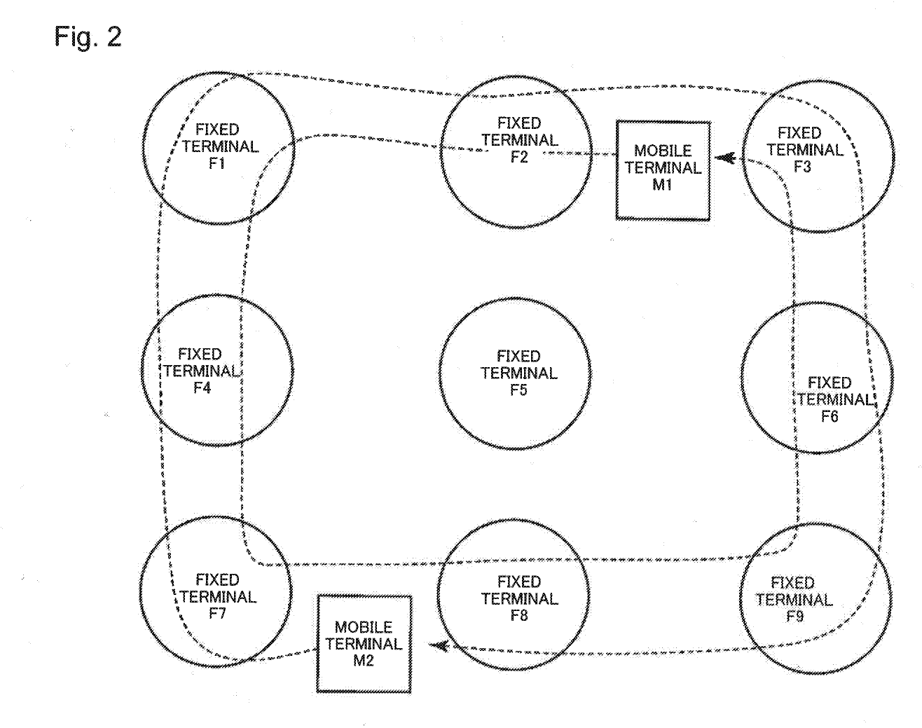

Further, since residence at a fixed location represents a communication time between a fixed terminal Fi and a mobile terminal Mj in the examples of the information delivery systems in FIGS. 1 and 2, another method may be a method of counting a communication time at each location and calculating the time as a residence time. Accordingly, as long as a residence time at each location can be calculated, the residence time calculation unit 3301 does not necessarily need to use the location information checking unit 1105. A residence time value may be obtained by calculating a residence time at each location, or using a calculation result related to time such as an average value, a shortest time, or a longest time of residence times at all locations. The residence time calculation unit 3301 conveys the calculation result to the switching determination unit 3303.

The travel time calculation unit 3302 calculates the time required for a mobile terminal Mj to travel from one location to another location. A method of periodically acquiring positional information by the location information checking unit 1105 and counting the time required for traveling from one location to another location may be cited as an example of travel time measurement.

Further, since a fixed terminal Fi and a mobile terminal Mj communicate with one another while staying at a fixed location in the examples of the information delivery systems in FIGS. 1 and 2, another method may be a method of counting a time between occurrence of a communication and occurrence of a next communication, and calculating the time as a travel time. Accordingly, as long as a residence time at each location can be calculated, the travel time calculation unit 3302 does not necessarily need to use the location information checking unit 1105. A travel time value may be calculated for each combination of a travel source and a travel destination, or may be obtained by using a calculation result related to time such as an average value, a shortest time, or a longest time of travel times for all combinations of travel sources and travel destinations. The travel time calculation unit 3302 conveys the calculation result to the switching determination unit 3303.

Based on a residence time calculated by the residence time calculation unit 3301 and a travel time calculated by the travel time calculation unit 3302, the switching determination unit 3303 determines which of a plurality of destination candidates stored in the delivery location storage unit 3104 is to be selected.

In general, when a travel time is long (or a distance between fixed spots is long) and a residence time is short (an amount of handled information is small) [when a first time T(1) is long and a third time T(3) is short], it is better to deliver every piece of information at every location, as is the case with a candidate 3 in FIG. 32. The reason is that even when every piece of information is replicated, increase in the residence time is small. Note that while a value of the third time T(3) becomes greater, an increased amount thereof is small. On the other hand, by preparing a replicate at every location, a reaching time [first time T(1)] required for a mobile terminal finally transporting information to arrive at a fixed terminal and replicate the information becomes substantially shorter.

Under a reverse condition, that is, when a travel time is short (or a distance between fixed terminals is short) and a residence time is long (an amount of handled information is large) [when a first time T(1) is short and a third time T(3) is long], it is better to replicate information only at a destination, as is the case with a candidate 1 in FIG. 32. The reason is that when an amount of handled information is large, the third time T(3) is non-negligible and time corresponding to the number of replication points is required, and therefore it is advantageous to narrow down delivery points. On the other hand, in a case that a travel time is short, even when a mobile terminal arrives at a fixed terminal and then travels to another location, the time required to arrive at the same fixed terminal again is short, and therefore even when a replicate of information is not generated at every location, the first time T(1) is short. Consequently, while the first time T(1) increases, an absolute value thereof is small, and it is advantageous to adopt a method of decreasing the term of the third time T(3) having a large absolute value.

As described above, the third example of the present invention is able to shorten a delivery time between generation of information and arrival of the information at a destination (a time between generation of information and arrival at a destination), by changing a delivery location in consideration of a communication environment such as a travel time and a residence time.

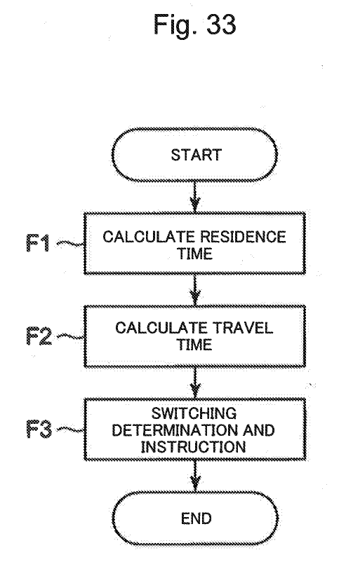

Next, referring to FIG. 33, a processing flow in the terminal (communication device) 3000 according to the third example will be described.

A flow of generation processing when generating information in the terminal 3000 according to the third example, a flow of reception processing when the terminal 3000 encounters another terminal and receives information from the another terminal, and a flow of transmission processing when the terminal 3000 encounters another terminal and transmits information to the another terminal are identical to those in the aforementioned first example, and therefore description thereof is omitted.

FIG. 33 is a flowchart illustrating a flow of switching processing for determining which of a plurality of delivery location candidates is to be adopted.

The switching processing in the switching processing unit 3300 in FIG. 33 is started periodically or by occurrence of an event such as an encounter with a terminal and arrival at a fixed location.

In processing F1, the residence time calculation unit 3301 counts a residence time at a certain location, while checking location information registered in the location information checking unit 1105. Then, the residence time calculation unit 3301 determines a residence time at a present moment for determination in the switching determination unit 3303. After the processing, the process is proceeded to processing F2.

In the processing F2, the travel time calculation unit 3302 counts a travel time from a certain location to an adjacent location, while checking location information registered in the location information checking unit 1105. Then, the travel time calculation unit 3302 determines a travel time at the present moment for determination in the switching determination unit 3303. After the processing, the process is proceeded to processing F3.

In the processing F3, based on the residence time obtained from the residence time calculation unit 3301 and the travel time obtained from the travel time calculation unit 3302, the switching determination unit 3303 determines which of a plurality of delivery location candidates stored in the delivery location storage unit 3104 is to be adopted.

While the third example has been described by taking a case that the delivery location storage unit 3104 includes a database as illustrated in FIG. 32 as an example, any form may be used without being limited to the database in FIG. 32, as long as a correspondence between a delivery location and a destination (delivery destination) can be changed by an instruction by the switching processing unit 3300. The delivery location storage unit 3104 may use a method other than a database such as a form of determining a destination by a function and changing the function by an instruction by the switching processing unit 3300.

Further, in the third example, when determining destination information to be adopted from a plurality of candidates, the delivery location storage unit 3104 adopts a destination candidate as is. However, the delivery location storage unit 3104 may adopt AND information, OR information, NOT information, NAND information, NOR information, or EOR information of a plurality of destination information candidates, or a combination result thereof.

While the switching processing unit 3300 according to the third example determines which of a plurality of candidates stored in the delivery location storage unit 3104 is to be selected, in consideration of both of a travel time and a residence time, a determination may be made in consideration of only either of a travel time or a residence time. For example, when handling information with a constant data size, the switching processing unit 3300 may determine which of a plurality of candidates stored in the delivery location storage unit 3104 is to be selected, in consideration of only a travel time. Further, when a data size handled by only a certain system is changed, the switching processing unit 3300 may determine which of a plurality of candidates stored in the delivery location storage unit 3104 is to be selected, in consideration of only a residence time, without considering a travel time. Additionally, the switching processing unit 3300 may determine which of a plurality of candidates stored in the delivery location storage unit 3104 is to be selected, by, for example, dividing a residence time into a communicating time and a non-communicating time, being a factor other than a travel time and a residence time, and conforming to a more detailed determination criterion.

As is obvious from the description above, the terminal 3000 (information replication method) according to the third example of the present invention is able to shorten an information delivery time. The reason is that a delivery location is changed in consideration of a communication environment such as a travel time and a residence time.

### Example 4

Next, referring to drawings, a fourth example of the present invention will be described in detail.

The fourth example of the present invention relates to an information delivery method or an information replication method for promptly delivering information to a destination, a location, and a terminal by inter-terminal communication. The information replication method according to the fourth example of the present invention features determination of a delivery location where a replicate of delivery information is generated, based on a destination (information delivery destination), and generation of a replicate of delivery information only in a terminal encountered at the delivery location. The fourth example features processing in a replication location calculation unit determining a delivery location.

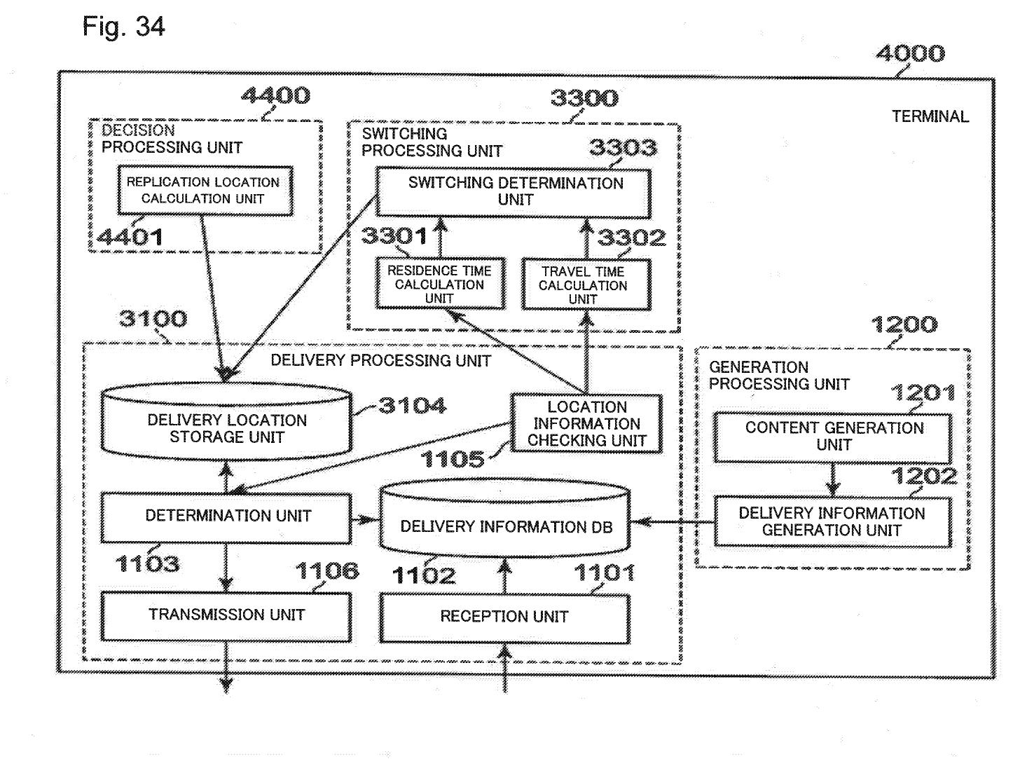

FIG. 34 is a block diagram illustrating a configuration of a terminal (communication device) 4000 according to the fourth example of the present invention. The illustrated terminal (communication device) 4000 also is used as a mobile terminal Mj or a fixed terminal Fi constituting the information delivery system illustrated in FIG. 1, or is used as a mobile terminal constituting the information delivery system illustrated in FIG. 25 or 26.

The terminal 4000 according to the fourth example includes a delivery processing unit 3100 responsible for a function of receiving delivery information from another terminal and a function of transmitting delivery information to another terminal, a generation processing unit 1200 generating delivery information, a switching processing unit 3300, and a decision processing unit 4400.

Processing performed by the generation processing unit 1200 generating delivery information is identical to that performed in the first example illustrated in FIG. 16, and therefore description thereof is omitted.

Processing performed by the delivery processing unit 3100 responsible for the function of receiving delivery information from another terminal and the function of transmitting delivery information to another terminal is identical to that performed in the third example illustrated in FIG. 31, and therefore description thereof is omitted.

Processing performed by the switching processing unit 3300 switching delivery location candidates is identical to that performed in the third example illustrated in FIG. 31, and therefore description thereof is omitted.

The decision processing unit 4400 includes a replication location calculation unit 4401.

The replication location calculation unit 4401 is a mechanism determining at which location a replicate is generated when a destination location (destination/delivery destination) is specified based on positional information of a fixed terminal. An algorithm for determining a location where information is replicated will be described below.

Whether or not to permit generation of a replicate at a certain location may be determined by applying an algorithm used in a common network and delay tolerant networking (DTN) (e.g. Algorithm 1 and Algorithm 2 below). Further, an algorithm deciding whether or not to permit replication for each location by using a feature of the present invention (specifying a replication location instead of a replication terminal ID) may be adopted (e.g. Algorithm 3, Algorithm 4, and Algorithm 5 below).

The replication location calculation unit 4401 registers a replication destination candidate decided by one of Algorithms 1 to 5 in the delivery location storage unit 3104 as a replication destination candidate list. As examples, five types of replication destination decision algorithms (Algorithms 1 to 5) will be described below.

### [Algorithm 1]

Algorithm 1 is an algorithm determining to generate a replicate of delivery information at only a destination (delivery destination). In other words, in Algorithm 1, only a fixed location being a destination (delivery destination) is specified as a replication destination candidate.

### [Algorithm 2]

Algorithm 2 is an algorithm generating a replicate of delivery information at every terminal. In other words, Algorithm 2 specifies every fixed terminal and mobile terminal to be a replication destination candidate, regardless of a destination (delivery destination).

### [Algorithm 3]

Algorithm 3 determines a connection between fixed terminals and specifies a fixed location on an intermediate route between a destination (delivery destination) and a source location (delivery source) as a replication destination candidate.

In Algorithm 3, a connection between fixed terminals is set first. The connection may be automatically set on the system side. Alternatively, when a mobile terminal moves from one fixed spot to another fixed spot, it may be regarded as generation of a virtual route, based on a history of the mobile terminal within a certain time period. Further, when there are a large number of such virtual routes, only a route (between one fixed spot and another fixed spot) passed by the certain number of mobile terminals or more may be regarded as a virtual route.

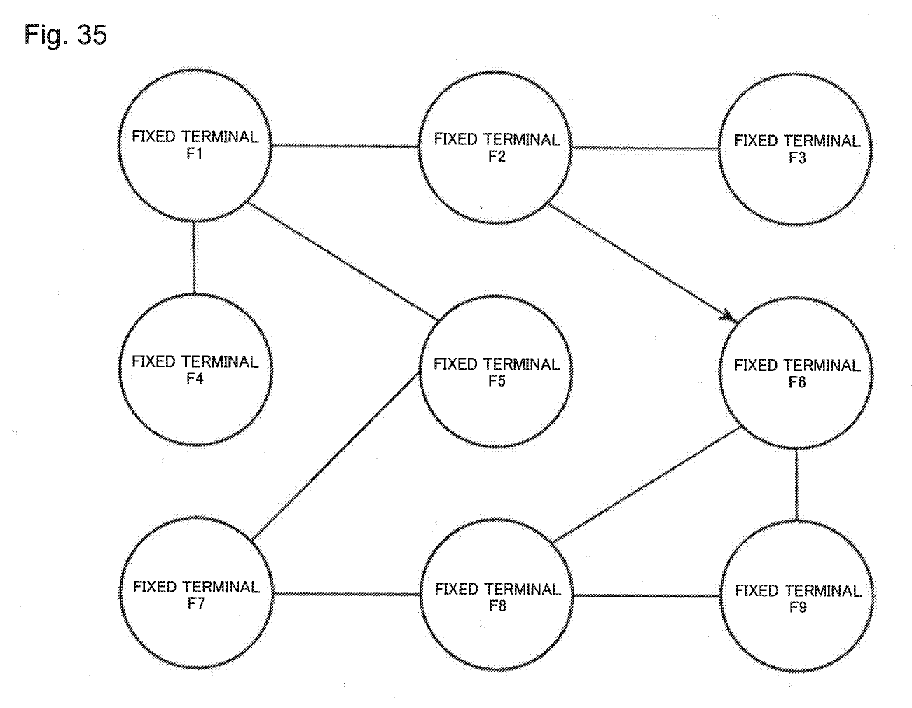

Next, Algorithm 3 decides a fixed location on an intermediate route between a destination (delivery destination) and an information source location (delivery source). It is assumed that connections between fixed spots (fixed terminals) are as depicted in an information delivery system illustrated in FIG. 35, and a fixed terminal F9 is a destination (delivery destination) and a fixed terminal F1 is an information source location (delivery source). In this case, intermediate locations connecting the first fixed terminal F1 and the ninth fixed terminal F9 become replication locations of information directed from the first fixed terminal F1 to the ninth fixed terminal F9.

In the example of the information delivery system illustrated in FIG. 35, F1->F5->F7->F8->F9, F1->F5->F7->F8->F6->F9, F1->F2->F6->F9, F1->F2->F6->F8->F9, and the like are replication destination candidates. Consequently, the first fixed terminal F1, a second fixed terminal F2, a fifth fixed terminal F5, a sixth fixed terminal F6, a seventh fixed terminal F7, an eighth fixed terminal F8, and the ninth fixed terminal F9 are fixed locations on intermediate routes from the first fixed terminal F1 to the ninth fixed terminal F9.

Consequently, the aforementioned fixed locations become information replication destination candidates. In this example, for information being generated in the first fixed terminal F1 and specifying the ninth fixed terminal F9 as a destination (delivery destination), the first fixed terminal F1, the second fixed terminal F2, the fifth fixed terminal F5, the sixth fixed terminal F6, the seventh fixed terminal F7, the eighth fixed terminal F8, and the ninth fixed terminal F9 become information replication destination candidates.

While all of a plurality of routes connecting the destination (delivery destination) and the source location (delivery source) have been specified as information replication destination candidates in the description above, only part of the routes may be selected as an information replication destination candidate. For example, out of the four aforementioned candidates, only one specific candidate such as F1->F5->F7->F8->F9 may be specified as an information replication destination candidate. Further, only a partial candidate of a certain route may be set as an information replication location. For example, the fifth fixed terminal F5, the seventh fixed terminal F7, and the ninth fixed terminal F9, being part of the aforementioned specific candidate route F1->F5->F7->F8->F9, may only be specified as information replication points.

### [Algorithm 4]

Algorithm 4 first determines a connection between fixed terminals and sets a cost to the connection. Then, Algorithm 4 calculates a cost of an intermediate route between a destination (delivery destination) and a source location (delivery source) and specifies a fixed location on a route with the highest/lowest cost value as an information replication destination candidate.

Algorithm 4 first sets a connection between fixed terminals. At this time, Algorithm 4 sets some cost to each connection. For example, Algorithm 4 may set the number of mobile terminals passing the connection within a unit time as a cost. Alternatively, after determining a connection between fixed terminals similarly to Algorithm 3, Algorithm 4 may set a physical distance thereof as a cost. Additionally, when a mobile terminal exists at a certain fixed terminal, Algorithm 4 may express a probability of next fixed terminal to travel to and set a value thereof as a cost.

Next, based on a relation between fixed terminals set with costs, Algorithm 4 decides a route connecting the destination (delivery destination) and the source location (delivery source) with the highest/lowest cost. As a searching method of a cost-minimizing route between a destination (delivery destination) and a source location (delivery source) in a state that a cost is set to a connection between fixed terminals, various methods such as Dijkstra's method may be used. When searching for a cost-maximizing route, the route may be derived by a similar technique (Dijkstra's method) by redefining a reciprocal of a cost as a new cost. Further, as a decision method of the highest cost route, probabilities on a route from a source location (delivery source) to a destination (delivery destination) may be added up, and a route with the highest value thereof may be selected.

Consequently, from the description above, for example, Algorithm 4 selects a route with the highest or lowest cost being a physical distance, a stochastic value, a travel frequency, and the like, and specifies a fixed spot on the route as an information replication destination candidate.

While a route with the lowest or highest cost out of routes connecting a destination (delivery destination) and a source location (delivery destination) has been specified as an information replication destination candidate in the description above, it is possible to calculate costs for a plurality of routes and select a plurality of high-ranking routes. Further, similarly to aforementioned Algorithm 3, Algorithm 4 may set only part of candidates on a certain route as an information replication location.

### [Algorithm 5]

Algorithm 5 compares a positional direction vector connecting a position of a fixed terminal and a position of a destination (delivery destination) with a traveling direction vector indicating a traveling direction of a mobile terminal at a present moment, and when the comparison result of the direction vectors is a certain value, specifies the fixed location as an information replication destination candidate.

First, based on positions of fixed terminals, Algorithm 5 calculates a locational direction vector for every combination of fixed terminals.

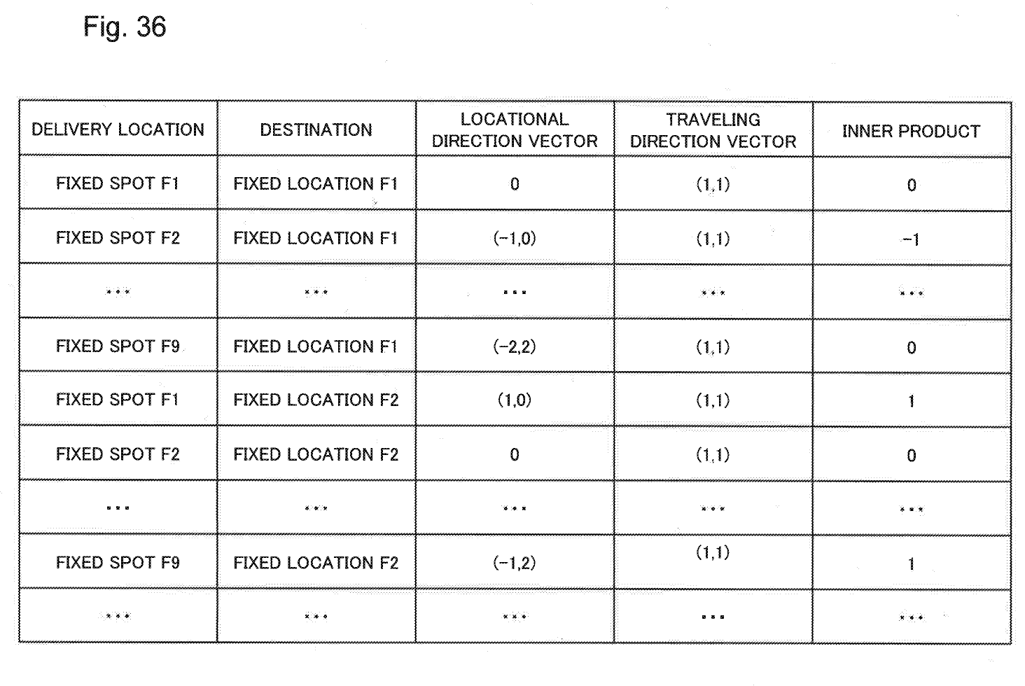

As an example, FIG. 36 indicates examples of positional direction vectors when positional relations between fixed terminals are as depicted in the information delivery system illustrated in FIG. 35. For simplification, in the example in FIG. 36, a distance to an adjacent fixed terminal is normalized to one. A distance in a leftward direction from a right side in FIG. 35 is specified as a first element and a distance in a downward direction from an upside in FIG. 35 is specified as a second element. A third column in FIG. 36 is a vector notation of a positional direction vector.

Next, based on a travel history of a mobile terminal, Algorithm 5 defines a traveling direction vector of the mobile terminal at the present moment. In the example in FIG. 36, a distance to an adjacent terminal is normalized to one. A distance in a leftward direction in FIG. 35 is specified as a first element, and a distance in a downward direction in FIG. 35 is specified as a second element.

Finally, Algorithm 5 calculates an inner product of the locational direction vector and the traveling direction vector (a fifth column in FIG. 36). Algorithm 5 specifies a combination of a delivery location and a destination (delivery destination) with an inner product greater or equal to a certain value or within a certain value range as an information replication destination candidate.

For example, it is assumed that a case that an inner product value is greater than or equal to zero is a condition of determination as an information replication destination candidate. In this case, Algorithm 5 selects at least fixed spots F1 and F9 as information replication destination candidates with respect to information with a destination (delivery destination) being the first fixed terminal F1 at an instant when a traveling direction vector is (1,1). Further, Algorithm 5 selects at least fixed spots F1, F2, and F9 as information replication destination candidates with respect to information with a destination (delivery destination) being the second fixed spot F2 at an instant when the traveling direction vector is (1,1).

Note that Algorithm 5 may perform inner product calculation as follows. First, Algorithm 5 previously divides a travel vector of a mobile terminal into N directions (N may be any integer value) and calculates an inner product for each direction. Then, when the mobile terminal actually travels, Algorithm 5 may obtain an inner product by referring to a vector table related to a traveling direction closest to the present traveling method. Alternatively, Algorithm 5 may calculate a traveling direction vector while traveling and calculate an inner product at each time.

While Algorithm 5 has been described to use an inner product of a vector, Algorithm 5 may decide a replication destination, based on a calculation result of a common vector operation such as an outer product or an absolute value of a vector.

While Algorithm 5 has been described taking a case that a replicate of information is generated with a probability being one at a fixed location selected as a replication destination candidate as an example, information may be stochastically replicated with respect to a replication destination candidate. The probability may be decided from a storage area size in a terminal, an amount of statistical data related to a replication order and destination information, and the like.

The fourth example does not describe processing of information existing at a replication source after replication of the information is performed. However, a deletion method of information at a replication source after a replicate of the information is generated, or a method of storing a replication count and deleting information at a replication source after replication is repeated a certain number of times may also be used.

As is obvious from the description above, the terminal 4000 (information replication method) according to the fourth example of the present invention is able to shorten an information delivery time. The reason is as follows. The terminal 4000 according to the fourth example determines an information replication location in consideration of a logical (e.g. temporal or stochastic) or physical distance from a source location (delivery source) of information to a destination (delivery destination) of the information. Consequently, the fourth example of the present invention is able to shorten a second time T(2) being a travel time.

Each unit in the terminals 1000, 2000, 3000, and 40000 according to the present example may be provided by using a combination of hardware and software. In a form of combining hardware and software, for example, each unit is provided as various means by operating hardware such as a control unit like a central processing unit (CPU), based on an information replication program stored in a read only memory (ROM). Further, the information replication program may be recorded in a recording medium and distributed. The information replication program recorded in the recording medium is read into a memory through a wired line, a wireless line, or the recording medium itself and operates the control unit or the like. Furthermore, as exemplifications of the recording medium, a magnetic disc such as a hard disk, an optical disc such as a compact disc read only memory (CD-ROM) and a digital versatile disc (DVD), a magneto-optical disc (MO), a semiconductor memory device, and the like may be listed.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

The whole or part of the example embodiments disclosed above can be described as, but not limited to, the following supplementary notes.

### Supplementary Note 1

A communication device transmitting delivery information to another terminal, the communication device comprising:

a determination processing unit determining whether or not to permit delivery of the delivery information, based on a delivery destination of the delivery information, location information of the communication device at a present moment, and delivery location information associating the delivery destination with a replication destination; and

a transmission processing unit transmitting the delivery information to the another terminal only when the determination processing unit determines to permit delivery.

### Supplementary Note 2

A communication device receiving delivery information from another terminal, the communication device comprising:

a reception processing unit receiving the delivery information from the another terminal; and

a determination processing unit determining whether or not to permit import of the delivery information received by the reception processing unit, based on a delivery destination of the delivery information, location information of the communication device at a present moment, and delivery location information associating the delivery destination with a replication destination.

### Supplementary Note 3

A communication device receiving delivery information from a first other terminal and transmitting the delivery information to a second other terminal, the communication device comprising:

a reception processing unit receiving the delivery information from the first other terminal;

a determination processing unit determining whether or not to permit delivery of the delivery information and determining whether or not to permit import of the delivery information received by the reception processing unit, based on a delivery destination of the delivery information, location information of the communication device at a present moment, and delivery location information associating the delivery destination with a replication destination; and

a transmission processing unit transmitting the delivery information to the second other terminal only when the determination processing unit determines to permit delivery.

### Supplementary Note 4

The communication device according to any one of Supplementary Notes 1 to 3,

wherein the delivery information is obtained by adding information including at least one of the delivery destination and a delivery source of the delivery information to an information body.

### Supplementary Note 5

The communication device according to any one of Supplementary Notes 1 to 4, further comprising a switching processing unit changing the delivery location information depending on a communication environment.

### Supplementary Note 6

The communication device according to Supplementary Note 5,

wherein the switching processing unit determines the communication environment, based on information including at least one of a residence time of staying at a certain location and a travel time of traveling from one location to another location.

### Supplementary Note 7

The communication device according to any one of Supplementary Notes 1 to 6, further comprising a decision processing unit calculating a replication location and recording the calculation result as the delivery information in a storage unit in the determination processing unit.

### Supplementary Note 8

The communication device according to any one of Supplementary Notes 1 to 7, further comprising a generation processing unit generating the delivery information by adding information including at least one of the delivery destination and a delivery source of the delivery information to an information body.

### Supplementary Note 9

An information delivery system comprising a communication network including a plurality of fixed terminals and at least one mobile terminal traveling while communicating with the plurality of fixed terminals,

wherein delivery information generated at a delivery source being one of the plurality of fixed terminals is delivered to a delivery destination being another one of the plurality of fixed terminals through the mobile terminal,

each of the plurality of fixed terminals includes the communication device according to any one of Supplementary Notes 1 to 3, and

the mobile terminal includes the communication device according to Supplementary Note 3.

### Supplementary Note 10

An information delivery system comprising a communication network including a plurality of mobile terminals,

wherein delivery information is delivered between the plurality of mobile terminals, and

each of the plurality of mobile terminals includes the communication device according to any one of claims 1 to 3.

### Supplementary Note 11

An information replication method in a communication device transmitting delivery information to another terminal, the information replication method comprising:

a step of determining whether or not to permit delivery of the delivery information, based on a delivery destination of the delivery information, location information of the communication device at a present moment, and delivery location information associating the delivery destination with a replication destination; and

a step of transmitting the delivery information to the another terminal only when delivery is determined to be permitted.

### Supplementary Note 12

An information replication method in a communication device receiving delivery information from another terminal, the information replication method comprising:

a step of receiving the delivery information from the another terminal; and

a step of determining whether or not to permit import of the received delivery information, based on a delivery destination of the delivery information, location information of the communication device at a present moment, and delivery location information associating the delivery destination with a replication destination.

### Supplementary Note 13

An information replication method in a communication device receiving delivery information from a first other terminal and transmitting the delivery information to a second other terminal, the information replication method comprising:

a step of receiving the delivery information from the first other terminal;

a step of determining whether or not to permit delivery of the delivery information and determining whether or not to permit import of the received delivery information, based on a delivery destination of the delivery information, location information of the communication device at a present moment, and delivery location information associating the delivery destination with a replication destination; and

a step of transmitting the delivery information to the second other terminal only when delivery is determined to be permitted.

### Supplementary Note 14

The information replication method according to any one of Supplementary Notes 11 to 13,

wherein the delivery information is obtained by adding information including at least one of the delivery destination and a delivery source of the delivery information to an information body.

### Supplementary Note 15

The information replication method according to any one of Supplementary Notes 11 to 14, further comprising a step of changing the delivery location information depending on a communication environment.

### Supplementary Note 16

The information replication method according to Supplementary Note 15,

wherein the changing step determines the communication environment, based on information including at least one of a residence time of staying at a certain location and a travel time of traveling from one location to another location.

### Supplementary Note 17

The information replication method according to any one of Supplementary Notes 11 to 16, further comprising a step of calculating a replication location and recording the calculation result as the delivery information in a storage unit.

### Supplementary Note 18

The information replication method according to any one of Supplementary Notes 11 to 17, further comprising a step of generating the delivery information by adding information including at least one of the delivery destination and a delivery source of the delivery information to an information body.

### Supplementary Note 19

An information replication program recording medium recording an information replication program executed on a computer operating as a communication device transmitting delivery information to another terminal, the information replication program causing the computer to execute:

a procedure of determining whether or not to permit delivery of the delivery information, based on a delivery destination of the delivery information, location information of the communication device at a present moment, and delivery location information associating the delivery destination with a replication destination; and

a procedure of transmitting the delivery information to the another terminal only when delivery is determined to be permitted.

### Supplementary Note 20

An information replication program recording medium recording an information replication program executed on a computer operating as a communication device receiving delivery information from another terminal, the information replication program causing the computer to execute:

a procedure of receiving the delivery information from the another terminal; and

a procedure of determining whether or not to permit import of the received delivery information, based on a delivery destination of the delivery information, location information of the communication device at a present moment, and delivery location information associating the delivery destination with a replication destination.

### Supplementary Note 21

An information replication program recording medium recording an information replication program executed on a computer operating as a communication device receiving delivery information from a first other terminal and transmitting the delivery information to a second other terminal, the information replication program causing the computer to execute:

a procedure of receiving the delivery information from the first other terminal;

a procedure of determining whether or not to permit delivery of the delivery information and determining whether or not to permit import of the received delivery information, based on a delivery destination of the delivery information, location information of the communication device at a present moment, and delivery location information associating the delivery destination with a replication destination; and a procedure of transmitting the delivery information to the second other terminal only when delivery is determined to be permitted.

### Supplementary Note 22

The information replication program recording medium according to any one of Supplementary Notes 19 to 21,

wherein the delivery information is obtained by adding information including at least one of the delivery destination and a delivery source of the delivery information to an information body.

### Supplementary Note 23

The information replication program recording medium according to any one of Supplementary Notes 19 to 22, the information replication program further causing the computer to execute a procedure of changing the delivery location information depending on a communication environment.

### Supplementary Note 24

The information replication program recording medium according to Supplementary Note 23, wherein the changing procedure determines the communication environment, based on information including at least one of a residence time of staying at a certain location and a travel time of traveling from one location to another location.

### Supplementary Note 25

The information replication program recording medium according to any one of Supplementary Notes 19 to 24, the information replication program further causing the computer to execute a procedure of calculating a replication location and recording the calculation result as the delivery information in a storage unit.

### Supplementary Note 26

The information replication program recording medium according to any one of Supplementary Notes 19 to 25, the information replication program further causing the computer to execute a procedure of generating the delivery information by adding information including at least one of the delivery destination and a delivery source of the delivery information to an information body.

This application is based upon and claims the benefit of priority from Japanese patent application No. 2015-122965, filed on Jun. 18, 2015, the disclosure of which is incorporated herein in its entirety by reference.

### REFERENCE SIGNS LIST

100, 100A, 100B, 100C Communication device (terminal)
110 Determination processing unit
130 Transmission processing unit
140 Switching processing unit
150 Decision processing unit
160 Generation processing unit
200, 200A, 200B Communication device (terminal)
210 Determination processing unit
220 Reception processing unit
240 Switching processing unit
250 Decision processing unit
300, 300A, 300B, 300C Communication device (terminal)
310 Determination processing unit
320 Reception processing unit
330 Transmission processing unit
340 Switching processing unit
350 Decision processing unit
360 Generation processing unit
1000 Terminal (communication device)
1100 Delivery processing unit
1101 Reception unit
1102 Delivery information DB
1103 Determination unit
1104 Delivery location storage unit
1105 Location information checking unit
1200 Generation processing unit
1201 Content generation unit
1202 Delivery information generation unit
2000 Terminal (communication device)
2100 Delivery processing unit
2101 Reception unit
2103 Determination unit
2106 Transmission unit
3000 Terminal (communication device)
3100 Delivery processing unit
3104 Delivery location storage unit
3300 Switching processing unit
3301 Residence time calculation unit
3302 Travel time calculation unit
3303 Switching determination unit
4000 Terminal (communication device)
4400 Decision processing unit
4401 Replication location calculation unit

What is claimed is:

1. A communication device transmitting delivery information to another terminal, the communication device comprising:
a determination processing unit determining whether or not to permit delivery of the delivery information, based on a delivery destination of the delivery information, location information of the communication device at a present moment, and delivery location information associating the delivery destination with a replication destination; and
a transmission processing unit transmitting the delivery information to the another terminal only when the determination processing unit determines to permit delivery.

2. A communication device receiving delivery information from another terminal, the communication device comprising:
a reception processing unit receiving the delivery information from the another terminal; and
a determination processing unit determining whether or not to permit import of the delivery information received by the reception processing unit, based on a delivery destination of the delivery information, location information of the communication device at a present moment, and delivery location information associating the delivery destination with a replication destination.

3. A communication device receiving delivery information from a first other terminal and transmitting the delivery information to a second other terminal, the communication device comprising:
a reception processing unit receiving the delivery information from the first other terminal;
a determination processing unit determining whether or not to permit delivery of the delivery information and determining whether or not to permit import of the delivery information received by the reception processing unit, based on a delivery destination of the delivery information, location information of the communication device at a present moment, and delivery location information associating the delivery destination with a replication destination; and
a transmission processing unit transmitting the delivery information to the second other terminal only when the determination processing unit determines to permit delivery.

4. The communication device according to claim 1, wherein the delivery information is obtained by adding information including at least one of the delivery destination and a delivery source of the delivery information to an information body.

5. The communication device according to claim 1, further comprising a switching processing unit changing the delivery location information depending on a communication environment.

6. The communication device according to claim 5, wherein the switching processing unit determines the communication environment, based on information including at least one of a residence time of staying at a certain location and a travel time of traveling from one location to another location.

7. The communication device according to claim 1, further comprising a decision processing unit calculating a replication location and recording the calculation result as the delivery information in a storage unit in the determination processing unit.

8. The communication device according to claim 1, further comprising a generation processing unit generating the delivery information by adding information including at least one of the delivery destination and a delivery source of the delivery information to an information body.

9. An information delivery system comprising a communication network including a plurality of fixed terminals and at least one mobile terminal traveling while communicating with the plurality of fixed terminals, wherein
delivery information generated at a delivery source being one of the plurality of fixed terminals is delivered to a delivery destination being another one of the plurality of fixed terminals through the mobile terminal,
each of the plurality of fixed terminals includes a communication device transmitting delivery information to another terminal, the communication device comprising:
a determination processing unit determining whether or not to permit delivery of the delivery information, based on a delivery destination of the delivery information, location information of the communication device at a present moment, and delivery location information associating the delivery destination with a replication destination; and
a transmission processing unit transmitting the delivery information to the another terminal only when the determination processing unit determines to permit delivery, and
the mobile terminal includes a communication device receiving delivery information from a first other terminal and transmitting the delivery information to a second other terminal, the communication device comprising:
a reception processing unit receiving the delivery information from the first other terminal;
a determination processing unit determining whether or not to permit delivery of the delivery information and determining whether or not to permit import of the delivery information received by the reception processing unit, based on a delivery destination of the delivery information, location information of the communication device at a present moment, and delivery location information associating the delivery destination with a replication destination; and
a transmission processing unit transmitting the delivery information to the second other terminal only when the determination processing unit determines to permit delivery.

10. An information delivery system comprising a communication network including a plurality of mobile terminals, wherein
delivery information is delivered between the plurality of mobile terminals, and
each of the plurality of mobile terminals includes a communication device transmitting delivery information to another terminal, the communication device comprising:
a determination processing unit determining whether or not to permit delivery of the delivery information, based on a delivery destination of the delivery information, location information of the communication device at a present moment, and delivery location information associating the delivery destination with a replication destination; and
a transmission processing unit transmitting the delivery information to the another terminal only when the determination processing unit determines to permit delivery.

11. An information replication method in a communication device transmitting delivery information to another terminal, the information replication method comprising:
determining whether or not to permit delivery of the delivery information, based on a delivery destination of the delivery information, location information of the communication device at a present moment, and delivery location information associating the delivery destination with a replication destination; and
transmitting the delivery information to the another terminal only when delivery is determined to be permitted.

12. An information replication method in a communication device receiving delivery information from another terminal, the information replication method comprising:
receiving the delivery information from the another terminal; and
determining whether or not to permit import of the received delivery information, based on a delivery destination of the delivery information, location information of the communication device at a present moment, and delivery location information associating the delivery destination with a replication destination.

13. An information replication method in a communication device receiving delivery information from a first other terminal and transmitting the delivery information to a second other terminal, the information replication method comprising:
receiving the delivery information from the first other terminal;
determining whether or not to permit delivery of the delivery information and determining whether or not to permit import of the received delivery information, based on a delivery destination of the delivery information, location information of the communication device at a present moment, and delivery location information associating the delivery destination with a replication destination; and
transmitting the delivery information to the second other terminal only when delivery is determined to be permitted.

14. An information replication program recording medium recording an information replication program executed on a computer operating as a communication device transmitting delivery information to another terminal, the information replication program causing the computer to execute:
a procedure of determining whether or not to permit delivery of the delivery information, based on a delivery destination of the delivery information, location information of the communication device at a present moment, and delivery location information associating the delivery destination with a replication destination; and
a procedure of transmitting the delivery information to the another terminal only when delivery is determined to be permitted.

15. An information replication program recording medium recording an information replication program executed on a computer operating as a communication device receiving delivery information from another terminal, the information replication program causing the computer to execute:
a procedure of receiving the delivery information from the another terminal; and
a procedure of determining whether or not to permit import of the received delivery information, based on a delivery destination of the delivery information, location information of the communication device at a present moment, and delivery location information associating the delivery destination with a replication destination.

16. An information replication program recording medium recording an information replication program executed on a computer operating as a communication device receiving delivery information from a first other terminal and transmitting the delivery information to a second other terminal, the information replication program causing the computer to execute:
a procedure of receiving the delivery information from the first other terminal;
a procedure of determining whether or not to permit delivery of the delivery information and determining whether or not to permit import of the received delivery information, based on a delivery destination of the delivery information, location information of the communication device at a present moment, and delivery location information associating the delivery destination with a replication destination; and
a procedure of transmitting the delivery information to the second other terminal only when delivery is determined to be permitted.

17. An information delivery system comprising a communication network including a plurality of fixed terminals and at least one mobile terminal traveling while communicating with the plurality of fixed terminals, wherein
delivery information generated at a delivery source being one of the plurality of fixed terminals is delivered to a delivery destination being another one of the plurality of fixed terminals through the mobile terminal,
each of the plurality of fixed terminals includes a communication device receiving delivery information from another terminal, the communication device comprising:
a reception processing unit receiving the delivery information from the another terminal; and
a determination processing unit determining whether or not to permit import of the delivery information received by the reception processing unit, based on a delivery destination of the delivery information, location information of the communication device at a present moment, and delivery location information associating the delivery destination with a replication destination, and
the mobile terminal includes a communication device receiving delivery information from a first other terminal and transmitting the delivery information to a second other terminal, the communication device comprising:
a reception processing unit receiving the delivery information from the first other terminal;
a determination processing unit determining whether or not to permit delivery of the delivery information and determining whether or not to permit import of the delivery information received by the reception processing unit, based on a delivery destination of the delivery information, location information of the communication device at a present moment, and delivery location information associating the delivery destination with a replication destination; and
a transmission processing unit transmitting the delivery information to the second other terminal only when the determination processing unit determines to permit delivery.

18. An information delivery system comprising a communication network including a plurality of fixed terminals and at least one mobile terminal traveling while communicating with the plurality of fixed terminals, wherein
delivery information generated at a delivery source being one of the plurality of fixed terminals is delivered to a delivery destination being another one of the plurality of fixed terminals through the mobile terminal,
each of the plurality of fixed terminals includes a communication device receiving delivery information from a first other terminal and transmitting the delivery information to a second other terminal, the communication device comprising:
a reception processing unit receiving the delivery information from the first other terminal;
a determination processing unit determining whether or not to permit delivery of the delivery information and determining whether or not to permit import of the delivery information received by the reception processing unit, based on a delivery destination of the delivery information, location information of the communication device at a present moment, and delivery location information associating the delivery destination with a replication destination; and
a transmission processing unit transmitting the delivery information to the second other terminal only when the determination processing unit determines to permit delivery, and
the mobile terminal includes a communication device receiving delivery information from a first other terminal and transmitting the delivery information to a second other terminal, the communication device comprising:
a reception processing unit receiving the delivery information from the first other terminal;
a determination processing unit determining whether or not to permit delivery of the delivery information and determining whether or not to permit import of the delivery information received by the reception processing unit, based on a delivery destination of the delivery information, location information of the communication device at a present moment, and delivery location information associating the delivery destination with a replication destination; and
a transmission processing unit transmitting the delivery information to the second other terminal only when the determination processing unit determines to permit delivery.

19. An information delivery system comprising a communication network including a plurality of mobile terminals, wherein
delivery information is delivered between the plurality of mobile terminals, and
each of the plurality of mobile terminals includes a communication device receiving delivery information from another terminal, the communication device comprising:
a reception processing unit receiving the delivery information from the another terminal; and
a determination processing unit determining whether or not to permit import of the delivery information received by the reception processing unit, based on a delivery destination of the delivery information, location information of the communication device at a present moment, and delivery location information associating the delivery destination with a replication destination.

20. An information delivery system comprising a communication network including a plurality of mobile terminals, wherein
delivery information is delivered between the plurality of mobile terminals, and
each of the plurality of mobile terminals includes a communication device receiving delivery information from a first other terminal and transmitting the delivery information to a second other terminal, the communication device comprising:
a reception processing unit receiving the delivery information from the first other terminal;
a determination processing unit determining whether or not to permit delivery of the delivery information and determining whether or not to permit import of the delivery information received by the reception processing unit, based on a delivery destination of the delivery information, location information of the communication device at a present moment, and delivery location information associating the delivery destination with a replication destination; and
a transmission processing unit transmitting the delivery information to the second other terminal only when the determination processing unit determines to permit delivery.
